(19) United States
(12) Patent Application Publication
(10) Pub. No.: US 2025/0301286 A1
(43) Pub. Date: Sep. 25, 2025

(54) SENSING METHOD AND SENSING SERVICE PROVISIONING METHOD USING INTEGRATED SENSING AND COMMUNICATION AND COMMUNICATION SYSTEM PROVIDING THE SAME

(71) Applicant: Electronics and Telecommunications Research Institute, Daejeon (KR)

(72) Inventor: Seung-Ik LEE, Daejeon (KR)

(73) Assignee: Electronics and Telecommunications Research Institute, Daejeon (KR)

(21) Appl. No.: 19/083,568

(22) Filed: Mar. 19, 2025

(30) Foreign Application Priority Data
Mar. 19, 2024 (KR) 10-2024-0038027
Jan. 23, 2025 (KR) 10-2025-0010627

(51) Int. Cl. H04W 4/38; H04W 48/16

(52) U.S. Cl. CPC H04W 4/38; H04W 48/16

(57) ABSTRACT

A sensing method using integrated sensing and communication (ISAC), according to an exemplary embodiment of the present disclosure, may include: receiving, via a sensing entity capable of communicating, a sensing request to obtain sensing information of a target; generating a sensing trigger based on the sensing request; and communicating with the sensing entity so that sensing of the target is performed using preconfigured sensing device configuration information, based on the sensing trigger, wherein the preconfigured sensing device configuration information includes information on a sensing device capable of sensing the target and the sensing entity associated with the sensing device.

### CROSS-REFERENCE TO RELATED APPLICATIONS

This application claims priority to Korean Patent Applications No. 10-2024-0038207, filed on Mar. 19, 2024, and No. 10-2025-0010627, filed on Jan. 23, 2025, with the Korean Intellectual Property Office (KIPO), the entire contents of which are hereby incorporated by reference.

### BACKGROUND

### 1. Technical Field

The present disclosure relates to a field of communication technologies, and more particularly, to a technique for sensing a target using a communication network and delivering the sensing information through the communication network.

### 2. Related Art

The content described in this section is provided solely as background information for exemplary embodiments of the present disclosure and does not constitute prior art.

In a wireless communication network, electronic devices such as base stations (BS) and user equipments (UEs) communicate wirelessly to transmit and receive data. Sensing refers to a process of acquiring information on the surroundings of a device. It may also be used to detect various attributes of an object, such as its location, speed, distance, direction, shape, or texture. Such information may be utilized to enhance communication within the network and for other application-specific purposes.

Sensing in communication networks has typically been limited to active sensing techniques accompanied by devices that receive and process radio frequency (RF) sensing signals. Other sensing techniques, such as passive sensing (e.g. radar) and non-RF sensing (e.g. video imaging and other sensors), may address some limitations of active sensing. However, these other techniques are typically implemented as standalone systems separate from communication networks.

The 5G communication system has been designed with a focus on communication functions, and sensing technologies are performed in separate and independent systems. Sensing technologies independent of communication systems cause inefficient use of resources and act as major factors that degrade the reliability and quality of integrated sensing data. Therefore, improvements to address these issues are required.

### SUMMARY

The present disclosure has been devised to address the problems of the related art, and the present disclosure is directed to proposing network functions and procedures for implementing Integrated Sensing and Communication (ISAC) technology.

The ISAC is proposed as a technology that enables simultaneous communication and sensing by integrating mobile communication and sensing techniques within a single network.

The ISAC aims to support key application scenarios such as autonomous driving, smart cities, factory automation, and public safety in next-generation mobile communication systems, such as 5G-Advanced and 6G.

The present disclosure is directed to integrating communication and sensing through ISAC, optimizing network resources, and effectively managing sensing data.

The present disclosure is directed to providing means for localizing functions for storing, processing, and analyzing sensing data, thereby reducing data transmission delay, ensuring quality of service (QoS), and efficiently managing data.

The present disclosure is further directed to providing means specialized in processing and analyzing sensing data, thereby ensuring real-time performance when analyzing network and sensing data and enhancing reliability and accuracy of sensing results.

A sensing method using ISAC, according to an exemplary embodiment of the present disclosure, may comprise: receiving, via a sensing entity capable of communicating, a sensing request to obtain sensing information of a target; generating a sensing trigger based on the sensing request; and communicating with the sensing entity so that sensing of the target is performed using preconfigured sensing device configuration information, based on the sensing trigger.

According the present disclosure, the preconfigured sensing device configuration information may include information on a sensing device capable of sensing the target and/or the sensing entity associated with the sensing device.

The sensing method may further comprise: obtaining information on an Access and Mobility Management (AMF) network function (NF) related to the preconfigured sensing device configuration information from a Unified Data Management (UDM) NF, based on the sensing trigger.

The sensing method may further comprise: transmitting, to the sensing entity, configuration parameters or a control policy related to the sensing device of the sensing entity while communicating with the sensing entity; and after transmitting the configuration parameters or the control policy related to the sensing device, managing a result of configuring the sensing device based on the configuration parameters or the control policy of the sensing device of the sensing entity.

The sensing method may further comprise: discovering a sensing data repository function (SDRF) for storing and processing sensing data in a localized data storage based on the sensing request.

The sensing method may further comprise: processing sensing data received by the SDRF from the sensing entity; and managing the processed sensing data together with information on the SDRF.

The sensing method may further comprise: performing, by using a Network Data Analytics Function (NWDAF), at least one of preprocessing of sensing data, analysis of the sensing data, optimization of configuration of the sensing entity, or analysis of sensing result calculation based on the sensing request.

The NWDAF may perform at least one of the preprocessing of the sensing data, the analysis of the sensing data, the optimization of the configuration of the sensing entity, or the analysis of the sensing result calculation using an analysis function based on artificial intelligence or machine learning.

A sensing service provisioning method using ISAC, according to another exemplary embodiment of the present disclosure, may comprise: receiving, via a sensing entity capable of communicating, a sensing monitoring request for obtaining sensing information of a target, the sensing monitoring request including an event condition; communicating with the sensing entity so that sensing of the target is performed using preconfigured sensing device configuration information, based on the sensing monitoring request; receiving sensing data from the sensing entity; generating an analysis result for the sensing data based on whether the event condition is satisfied; and providing the analysis result in response to the sensing monitoring request.

According to the present disclosure, the preconfigured sensing device configuration information may include information on a sensing device capable of sensing the target and/or the sensing entity associated with the sensing device.

The sensing service provisioning method may further comprise: discovering a sensing data repository function (SDRF) for storing and processing the sensing data in a localized data storage based on the sensing monitoring request.

The sensing service provisioning method may further comprise: processing the sensing data received by the SDRF from the sensing entity; and managing the processed sensing data together with information on the SDRF.

The sensing service provisioning method may further comprise: performing, by using a Network Data Analytics Function (NWDAF), at least one of preprocessing of the sensing data, analysis of the sensing data, optimization of configuration of the sensing entity, or analysis of sensing result calculation based on the sensing request.

The NWDAF may perform at least one of the preprocessing of the sensing data, the analysis of the sensing data, the optimization of the configuration of the sensing entity, or the analysis of the sensing result calculation using an analysis function based on artificial intelligence or machine learning.

A communication network system using ISAC, according to another exemplary embodiment of the present disclosure, may comprise at least one entity, the at least one entity may comprise: a computer-readable memory storing at least one instruction and at least one processor.

According to the present disclosure, when executed by the at least one processor, the at least one instruction may cause the at least one entity to perform: receiving, via a sensing entity capable of communicating, a sensing request to obtain sensing information of a target; generating a sensing trigger based on the sensing request; and communicating with the sensing entity so that sensing of the target is performed using preconfigured sensing device configuration information, based on the sensing trigger.

According to the present disclosure, the preconfigured sensing device configuration information may include information on a sensing device capable of sensing the target and/or the sensing entity associated with the sensing device.

The at least one instruction may further cause the at least one entity to perform: obtaining information on an Access and Mobility Management (AMF) network function (NF) related to the preconfigured sensing device configuration information from a Unified Data Management (UDM) NF, based on the sensing trigger.

The at least one instruction may further cause the at least one entity to perform: transmitting, to the sensing entity, configuration parameters or a control policy related to the sensing device of the sensing entity while communicating with the sensing entity; and after transmitting the configuration parameters or the control policy related to the sensing device, managing a result of configuring the sensing device based on the configuration parameters or the control policy of the sensing device of the sensing entity.

The at least one instruction may further cause the at least one entity to perform: discovering a sensing data repository function (SDRF) for storing and processing sensing data in a localized data storage based on the sensing request.

The at least one instruction may further cause the at least one entity to perform: processing sensing data received by the SDRF from the sensing entity; and managing the processed sensing data together with information on the SDRF.

The at least one instruction may further cause the at least one entity to perform: performing, by using a Network Data Analytics Function (NWDAF), at least one of preprocessing of sensing data, analysis of the sensing data, optimization of configuration of the sensing entity, or analysis of sensing result calculation based on the sensing request.

The NWDAF may perform at least one of the preprocessing of the sensing data, the analysis of the sensing data, the optimization of the configuration of the sensing entity, or the analysis of the sensing result calculation using an analysis function based on artificial intelligence or machine learning.

The at least one instruction may further cause the at least one entity to perform: providing, in response to the sensing request, an analysis result of sensing data received via the sensing entity based on whether an event condition included in the sensing request is satisfied.

According to an exemplary embodiment of the present disclosure, the network functions and procedures for implementing ISAC technology can be implemented.

According to an exemplary embodiment of the present disclosure, communication and sensing can be integrated using ISAC, network resources can be optimized, and sensing data can be managed efficiently.

According to an exemplary embodiment of the present disclosure, by providing means for localizing functions for storing, processing, and analyzing sensing data, data transmission delay can be reduced, Quality of Service (QoS) can be guaranteed, and data can be managed efficiently.

According to an exemplary embodiment of the present disclosure, by providing means specialized in processing and analyzing sensing data, real-time performance can be secured when analyzing network and sensing data, and the reliability and accuracy of sensing results can be improved.

### BRIEF DESCRIPTION OF DRAWINGS

FIG. 1 is a conceptual diagram illustrating an Integrated Sensing and Communication (ISAC) service and a core network 100 supporting the service according to an exemplary embodiment of the present disclosure.

FIGS. 2 and 3 are conceptual diagrams illustrating operations for supporting an ISAC service according to an exemplary embodiment of the present disclosure.

FIG. 4 is a conceptual diagram illustrating a sensing method based on ISAC, a sensing service provisioning method, and a core network supporting the same according to an exemplary embodiment of the present disclosure.

FIG. 5 is a diagram conceptually illustrating a sensing method based on ISAC, a sensing service provisioning method, and a core network supporting the same according to another exemplary embodiment of the present disclosure.

FIGS. 6 to 9 are operational flowcharts illustrating a sensing request procedure for a sensing method based on ISAC according to an exemplary embodiment of the present disclosure.

FIGS. 10 to 13 are operational flowcharts illustrating a sensing monitoring procedure for a sensing service provisioning method based on ISAC according to another exemplary embodiment of the present disclosure.

FIGS. 14 to 18 are operational flowcharts illustrating a sensing request process for a sensing method based on ISAC according to another exemplary embodiment of the present disclosure.

FIGS. 19 to 23 are operational flowcharts illustrating a sensing request process for a sensing method based on ISAC according to another exemplary embodiment of the present disclosure.

FIG. 24 is a conceptual diagram illustrating an example of a generalized computing system in which an entity or a part thereof in the core network 100 capable of performing at least part of the processes in FIGS. 1 to 23 may be implemented.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Meanwhile, even if a technology is known prior to the filing date of the present disclosure, it may be included as part of the configuration of the present disclosure when necessary, and will be described herein without obscuring the spirit of the present disclosure. However, in describing the configuration of the present disclosure, a detailed description on matters that can be clearly understood by those skilled in the art as a known technology prior to the filing date of the present disclosure may obscure the purpose of the present disclosure, so excessively detailed description on the known technology will be omitted.

However, the purpose of the disclosure is not to claim the rights to these known technologies, and the contents of the known technologies may be included as part of the disclosure without departing from the scope of the disclosure.

Hereinafter, exemplary embodiments of the disclosure will be described in more detail with reference to the accompanying drawings. To facilitate an overall understanding in the description of the disclosure, the same reference numerals will be assigned to the same components throughout the accompanying drawings, and redundant descriptions thereof will be omitted.

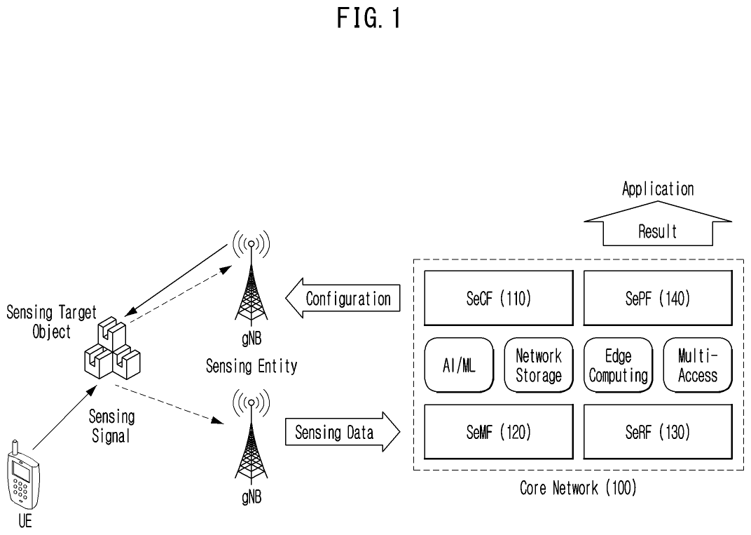

FIG. 1 is a conceptual diagram illustrating an Integrated Sensing and Communication (ISAC) service and a core network 100 supporting the service according to an exemplary embodiment of the present disclosure.

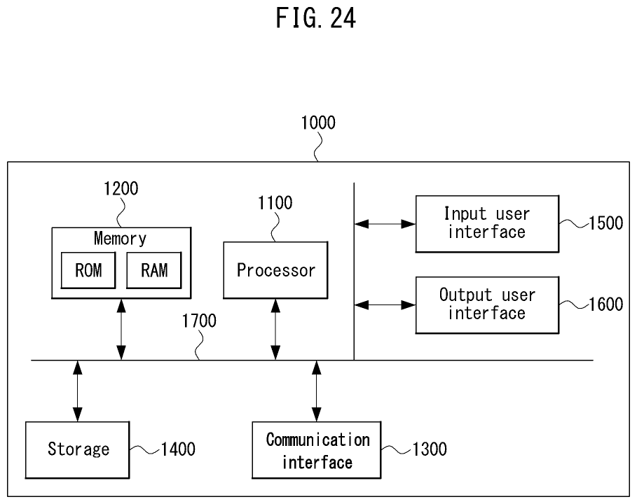

Referring to FIG. 1 and FIG. 24 to be described later, entities in a core network 100 according to an exemplary embodiment of the present disclosure, and/or entities involved in a sensing process by an ISAC service may each include a computer-readable memory 1200 for storing at least one instruction, and a processor 1100 for executing the at least one instruction.

The core network 100 supporting the ISAC service may include various network functions (NFs). Although not illustrated in FIG. 1, the core network 100 may include an Application Function (AF), an Access and Mobility management Function (AMF), an Application Service Provider (ASP), a Location Management Function (LMF), a Network Exposure Function (NEF), an Operation, Administration, and Maintenance (OAM), a Session Management Function (SMF), a Policy Control Function (PCF), a Unified Data Management (UDM), a Unified Data Repository (UDR), a Data Network (DN) or a local part of DN with local access to the data network, a user plane function (UPF), a (Radio)Access Network ((R)AN), and a User Equipment (UE).

Each NF may support the following functions.

The AMF may provide functionality for access and mobility management on a per-UE basis, and one UE may be basically connected to one AMF.

The DN may refer to, for example, an operator service, Internet access, or third-party service. The DN may transmit a downlink protocol data unit (PDU) to the UPF or receive a PDU transmitted from the UE via the UPF. The local part of DN may refer to a data network, which is a part of DN and is locally accessible, with a short data transmission path. The term may refer to a DN where edge application servers supporting edge computing services are deployed.

The PCF may receive information on packet flows from an application server and provide functionality for determining policies such as mobility management and session management. Specifically, the PCF may support functionalities such as providing a unified policy framework for controlling network operations, providing policy rules so that control plane function(s) (e.g. AMF, SMF, etc.) can enforce the policy rules, and implementing a front end for accessing relevant subscription information in the UDR to make policy decisions.

The SMF may provide session management functionality, and when a UE has multiple sessions, the respective sessions may be managed by different SMFs.

The UDM may store user subscription data, policy data, and the like.

The UPF may deliver a downlink PDU received from the DN to the UE via the (R)AN and deliver an uplink PDU received from the UE via the (R)AN to the DN. An uplink classifier (ULCL) may refer to a UPF that has a functionality of classifying uplink traffic for transmission. A local UPF (L-UPF) may serve as a PDU Session anchor for a session transmitted to the local part of DN.

A Sensing Network Function (SNF) may be an NF supporting ISAC services. The SNF may perform at least one of receiving an ISAC service request, authenticating the request, generating and configuring ISAC service quality control policies, discovering and selecting network device(s) and terminal(s) performing sensing operations, and collecting and processing sensing results. These operations may be configured or implemented as two logically separated NFs: a Sensing Service Gateway/Centre and a Sensing Management Function.

For example, when configured and implemented as logically separated NFs, the Sensing Service Gateway/Centre may be centrally deployed to receive and authenticate ISAC service requests and perform operations such as generating ISAC service quality control policies, while the Sensing Management Function may be deployed in a distributed and regional manner to perform operations such as discovering and selecting network device(s) and terminal(s) for performing actual sensing operations and collecting and processing sensing results. The present disclosure does not limit how the Sensing Network Function is configured. That is, both an exemplary embodiment in which the function is configured as a single entity and an exemplary embodiment in which the function is separated into two or more entities are within the scope of the present disclosure.

The UE may be classified into a UE that actually requests an ISAC service and a UE that servers as a sensor detecting a sensing object to provide the ISAC service to the wireless communication system.

A base station of the (R)AN forming a radio access network may perform operations for detecting a sensing object as a sensor, in addition to transmission and reception of communication signals.

To control a quality of an ISAC service according to an exemplary embodiment of the present disclosure, ISAC service quality-related information may be used by the wireless communication system and a device external to the system that requests the ISAC service.

To describe exemplary embodiments below, the ISAC service quality-related information may be referred to as ‘Sensing Service Quality (SSQ)’.

Referring again to FIG. 1, the core network 100 according to an exemplary embodiment of the present disclosure may communicate with a sensing apparatus or a sensing device capable of sensing a sensing object (or target) or at least one entity capable of connecting to the sensing device. In this case, the sensing apparatus or the sensing device may be a device separate from a UE or gNB, or may be a UE or gNB itself.

The core network 100 may control, manage, or provide configuration information for sensing devices, as well as configuration information for entities connected to or constituting the sensing devices.

The core network 100 may receive sensing data obtained by the sensing devices through the entities connected to or constituting the sensing devices.

The core network 100 may include a Sensing entity Control network Function (SeCF) 110, a Sensing Management network Function (SeMF) 120, a Sensing Result calculation network Function (SeRF) 130, and a Sensing service Provisioning network Function (SePF) 140.

The core network 100 may provide sensing results obtained using the SeCF 110, the SeMF 120, the SeRF 130, and the SePF 140 to an application.

The core network 100 may provide AI/ML, network storage, edge computing, and/or multi-access functionalities using the SeCF 110, the SeMF 120, the SeRF 130, and the SePF 140.

In the present disclosure, the term ‘sensing entity’ may refer to, for convenience of description, an entity connected to or constituting a sensing device and capable of communicating with the core network 100. The sensing entity may be a device separate from the sensing device or the sensing device itself having a sensing functionality.

The sensing entity may be an entity within the (R)AN. The sensing entity may generally be a 3GPP- or 5G-based entity and may also be a non-3GPP entity.

The sensing entity may generally be deployed in a terrestrial communication network, but the sensing entity may also exist in aerial or satellite communication networks.

The sensing entity may transmit sensing information on a sensing object or sensing target to the core network 100 (or to an entity within the core network 100). In this case, if the sensing device is arranged separately from the sensing entity, sensing information from the sensing device may be delivered to the core network 100 via the sensing entity. If the sensing device has a sensing functionality, sensing information obtained by a sensor module implementing the sensing functionality may be transmitted to the core network 100 via a communication module of the sensing entity.

In addition, the core network 100 (or an entity within the core network 100) may control or manage a sensing process performed by the sensing entity based on the architecture illustrated in FIG. 1. The sensing entity may include a UE or a gNB, and the core network 100 (or an entity within the core network 100) may control or manage the sensing entity to transmit and receive wireless signals for sensing.

The core network 100 (or an entity within the core network 100) may acquire or receive sensing information on the sensing target by cooperating with the sensing entity or utilizing the sensing entity based on the architecture illustrated in FIG. 1.

The sensing entity/equipment/device in a 3GPP network may be a gNB or UE. A non-3GPP sensing device may be a LiDAR, laser, imaging sensor, temperature sensor, or the like.

In the case where the sensing entity is a gNB or UE in the 3GPP network, wireless signals for sensing the sensing target may use 5G NR. However, the spirit of the present disclosure is not limited by such an exemplary embodiment.

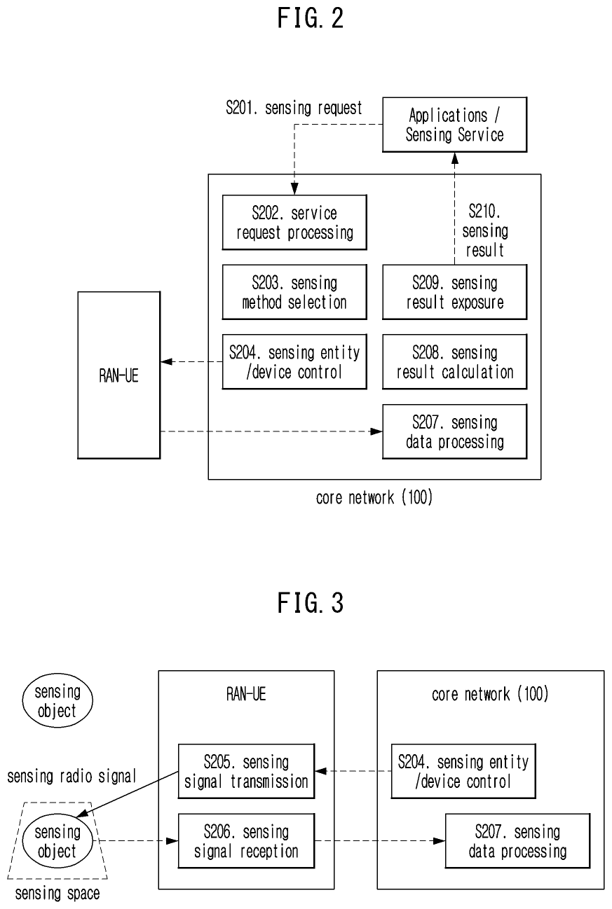

FIGS. 2 and 3 are conceptual diagrams illustrating operations for supporting an ISAC service according to an exemplary embodiment of the present disclosure.

Operations of the core network 100 illustrated in FIGS. 2 and 3 may be performed by various NFs within the above-described core network 100. These NFs may be performed by at least one entity within the core network 100, may be performed through cooperation of two or more entities, or individual NFs may be assigned to and performed by individual entities. The spirit of the present disclosure is not limited by the hardware implementation of the NFs within the core network 100.

Referring to FIGS. 2 and 3, the core network 100 may receive a sensing request from an application/sensing service side (S201).

After receiving the sensing request, the core network 100 may process the service request (S202).

The core network 100 may select a sensing method corresponding to the sensing request (S203).

The core network 100 may control a sensing device corresponding to the selected sensing method (S204).

The core network 100 may control a sensing entity within the RAN to transmit sensing signals for sensing a sensing object (target) within a sensing space (S205).

When the sensing entity within the RAN receives the sensing signals (S206), the sensing entity may deliver sensing data to the core network 100. The core network 100 may process the sensing data received from the sensing entity (S207).

The core network 100 may calculate a sensing result based on the sensing data (S208).

The core network 100 may expose the sensing result (S209).

The core network 100 may provide the sensing result (S210).

FIGS. 2 and 3 may be understood as illustrating basic operation layers according to an exemplary embodiment of the present disclosure.

According to an exemplary embodiment of the present disclosure, Table 1 below hierarchically defines the operations among the application, core, and sensing equipment, and the respective steps may be included in a life cycle from sensing initiation to result response.

TABLE 1

| Layers | Sensing Initiation/Request | Sensing Result/Response |
|---|---|---|
| Application | \textcircled{1} Service Request | \textcircled{10} Service Result |
| Core | \textcircled{2} Service Registration | \textcircled{9} Result Exposure |
| | Management | |
| | \textcircled{3} Sensing Method Selection | \textcircled{8} Result Calculation |
| | \textcircled{4} Sensing Equipment Control | \textcircled{7} Data Processing |
| Sensing | \textcircled{5} Sensing Initiation | \textcircled{6} Sensing Measurement |
| Equipment | | |

The application layer may manage sensing requests and result provision, the core layer may process sensing data, and the sensing equipment may perform data measurement.

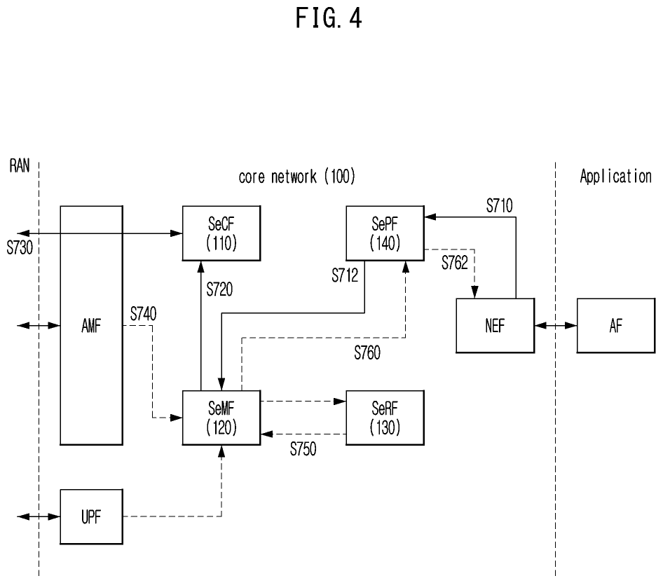

FIG. 4 is a conceptual diagram illustrating a sensing method based on ISAC, a sensing service provisioning method, and a core network supporting the same according to an exemplary embodiment of the present disclosure.

Referring to FIG. 4, the NEF within the core network 100 may receive a sensing request via the AF.

The SePF 140 may receive the sensing request via the NEF (S710).

The SePF 140 may deliver the sensing request to the SeMF 120 (S712).

The SeMF 120 may generate and transmit a sensing trigger to the SeCF 110 based on the sensing request (S720).

In this case, the sensing trigger may include a request for configuration information of sensing devices/sensing entities held by the SeCF 110.

The SeCF 110 may communicate with sensing entities within the RAN via the AMF (S730). In step S730, the configuration information held by the SeCF 110 may be delivered to the sensing entities within the RAN. The information delivered in the step S730 may include sensing configuration/policy information and registration information of sensing devices. The information delivered in the step S730 may be configuration information that enables at least one sensing entity to sense a sensing target.

Additionally or alternatively, the sensing entity may initiate sensing in response to a request from the SeMF 120.

The sensing data obtained by the sensing entity may be delivered to the SeMF 120 via the AMF S230 (S740).

In this case, the UPF may also deliver a part of the sensing data to the SeMF 120.

The SeMF 120 may deliver the sensing data to the SeRF 130 (S232), and the SeRF 130 may calculate a sensing result based on the sensing data and provide the sensing result to the SeMF 120 (S750).

The sensing result may be delivered from the SeMF 120 to the SePF 140 (S760).

The sensing result may be provided to the application side via the SePF 140, the NEF, and the AF (S762).

The SeCF 110 may select an infrastructure (sensing devices) that will transmit sensing wireless signals and control and configure operations of the sensing devices.

The SeMF 120 may collect, store, and transmit the measured sensing data.

The SeRF 130 may calculate the collected sensing data and generate the sensing result as a result of the calculation. The SeRF 130 may inspect the sensing result and manage a quality of the sensing result.

The SePF 140 may invoke or manage sensing-related integrated services. The SePF 140 may also provide the sensing result to an external application.

The core network 100 supporting ISAC according to an exemplary embodiment of the present disclosure may include the following new NFs and procedures.

The core network 100 in the exemplary embodiments of FIGS. 1 to 4 may include the SeCF 110, the SeMF 120, the SeRF 130, and the SePF 140 as new NFs. These NFs are core components for efficiently performing control, processing, calculation, and exposure of sensing data.

The SeCF 110 may define and control the configuration of the sensing entity, the SeMF 120 may collect and pre-process data, the SeRF 130 may analyze the data to generate a result, and the SePF 140 may provide the result to the service. The respective NFs may interact through messages and procedures to manage sensing data in an integrated manner.

The roles of the SeCF 110 are as follows.

The SeCF 110 may perform configuration and control on the sensing entity. The SeCF 110 may manage a configuration between the sensing entity and the sensing device and may configure the sensing entity and the sensing device in association.

Sensing device control and policy configuration: The SeCF 110 may perform detailed configuration of the sensing device operations in terms of time, space, and range, and may define management and sharing policies.

Sensing device selection: The SeCF 110 may select a device or a device group that is to perform transmission and reception of sensing signals. The SeCF 110 may search for and select a sensing entity associated with the sensing device or device group.

The roles of the SeMF 120 are as follows.

The SeMF 120 may perform collection, coordination, processing, and quality of service (QoS) management of the sensing data. The SeMF 120 may comprehensively manage storage and provision of the sensing data.

The SeMF 120 may instruct the sensing entity to perform a sensing operation and may coordinate and manage the sensing operation.

Sensing control flow management: The SeMF 120 may comprehensively manage the sensing control and operation invocation.

Sensing data management: The SeMF 120 may store, manage, and provide sensing data (including raw data), and may evaluate and manage the accuracy and response time of the data. The SeMF 120 may collect and coordinate the sensing data and may manage the quality of the sensing data based on QoS.

Sensing method selection: The SeMF 120 may map a sensing target object and a sensing area and may select an optimal sensing method for the sensing target object and the sensing area.

The roles of the SeRF 130 are as follows.

Sensing result calculation: The SeRF 130 may process sensing data, generate sensing results from the processed sensing data, and/or derive a result by applying filtering and mapping.

Result validity evaluation: The SeRF 130 may validate the sensing result and manage a quality of the result. In this case, the SeRF 130 may evaluate and manage the accuracy and response time of the sensing result for quality management.

The roles of the SePF 140 are as follows.

The SePF 140 may manage a service request and monitor event condition(s) included in the service request.

The SePF 140 may map the sensing result according to the service request and perform authentication and authorization for the service request.

Service request and authentication: The SePF 140 may manage the service request and authenticate and authorize the corresponding request.

Sensing data exposure: The SePF 140 may map the service request and the sensing result and provide them to an application service while maintaining security. The SePF 140 may maintain the security of the sensing data and sensing result and manage privacy.

Through the interaction of these NFs, the core network 100 may integrally manage the processes of sensing data request, control, processing, calculation, exposure, and response. To this end, the NFs may interact through messages and procedures. The core network 100 according to exemplary embodiments of the present disclosure may overcome the limitations of the 5G system and maximize the efficiency of ISAC technology.

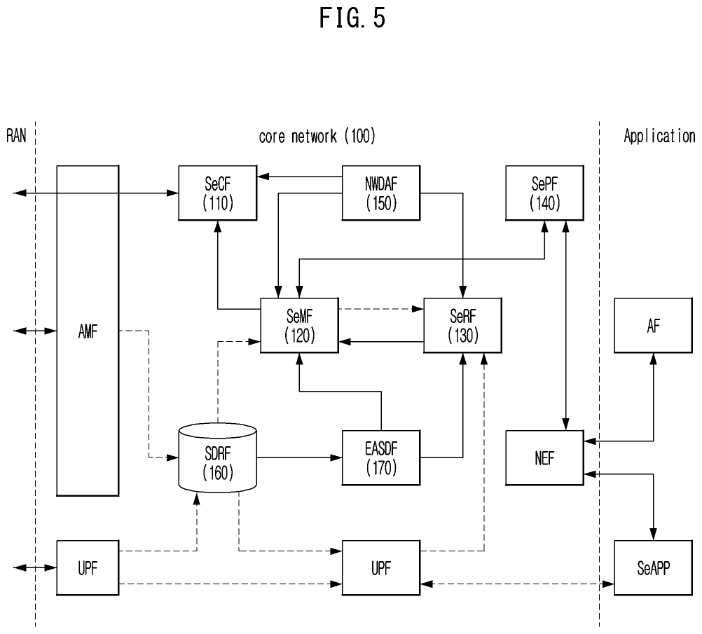

FIG. 5 is a diagram conceptually illustrating a sensing method based on ISAC, a sensing service provisioning method, and a core network supporting the same according to another exemplary embodiment of the present disclosure.

Referring to FIG. 5, compared to the exemplary embodiment of FIG. 4, an exemplary embodiment introducing a Sensing Data Repository Function (SDRF) 160 and an interaction procedure with a Network Data Analytics Function (NWDAF) 150 is illustrated in order to further enhance the efficiency and reliability of sensing data.

The role of the SDRF 160 is as follows.

Data storage and distributed processing: The SDRF 160 may store sensing data in a localized data store to reduce data transmission delay, improve data processing efficiency, and guarantee QoS.

The SDRF 160 may manage data in a centralized and/or distributed structure to enhance data resilience.

Data retrieval and QoS-based selection: The SDRF 160 may retrieve sensing data according to QoS requirements to minimize network delay.

The SDRF 160 may efficiently manage data collected from an NG-RAN and UEs, and may provide high-quality data by applying the QoS-based retrieval and selection function.

The role of the NWDAF 150 is as follows.

AI-based analysis support: The NWDAF 150 may support preprocessing of sensing data, optimization of device configuration, and efficiency improvement of result calculation by utilizing AI algorithms.

The SDRF 160 may analyze the network and sensing data in real time to improve QoS.

QoS management and optimization: The SDRF 160 may maximize network efficiency by predicting QoS of sensing data and optimizing resources.

The SDRF 160 may enhance reliability and accuracy of sensing results.

The SDRF 160 and the NWDAF 150 may maximize the performance of ISAC technology through interaction. The SDRF 160 may store and manage data collected from the NG-RAN and UEs, and the NWDAF 150 may generate QoS improvement information by analyzing the data provided by the SDRF 160. The QoS improvement information may be delivered to the SeMF 120 and the SeRF 130 to enhance efficiency of data processing and result calculation.

An Edge Application Server Discovery Function (EASDF) 170 illustrated in FIG. 5 may be a function for discovering an Edge Application Server (EAS). The EASDF 170 may be a component for supporting Multi-access Edge Computing (MEC).

Referring to FIGS. 1 to 5, exemplary embodiments of the present disclosure may present practical applicability of ISAC technology in various fields.

For example, ISAC technology may be utilized in analysis for road traffic management, air quality monitoring, and energy efficiency for a smart city.

For autonomous driving, ISAC technology may be utilized in a process of enhancing safety and efficiency through vehicle and traffic sensing data.

For factory automation, ISAC technology may be utilized in a process of quality control and operation optimization based on sensing data of production lines.

For public safety, ISAC technology may be utilized in processes such as drone-based surveillance, emergency rescue, and environmental monitoring.

The core network 100 according to an exemplary embodiment of the present disclosure may define major operations related to various sensing targets and may be subdivided as follows.

Detection of objects and movement detection within a designated space may be performed. For example, exemplary embodiments of the present disclosure may be applied to applications such as intruder monitoring within a home/building and pedestrian detection on roads.

Detection of environmental changes around a designated object may be performed. For example, exemplary embodiments of the present disclosure may be applied to applications such as collision detection and avoidance and driving assistance.

Detection of changes (e.g. position, speed, direction) in a moving object may be performed. For example, exemplary embodiments of the present disclosure may be applied to applications such as AGV driving route management and UAV control.

The present disclosure aims to provide a new network structure and procedure for implementing ISAC technology capable of performing communication and sensing simultaneously by integrating a mobile communication network and sensing technology.

One of the objectives of the present disclosure is integrated processing and management of sensing data.

An exemplary embodiment of the present disclosure may include new NFs such as the SeCF 110, the SeMF 120, the SeRF 130, the SePF 140 to efficiently process communication and sensing data.

Another objective of the present disclosure is improvement of QoS and reliability of sensing data.

An exemplary embodiment of the present disclosure may provide data transmission and computation procedures for minimizing processing delay of sensing data and improving reliability.

Another objective of the present disclosure is to support scalability and AI-based optimization. Efficiency of sensing may be maximized through data storage and AI-based analysis by introducing the SDRF 160 and the NWDAF 150.

The present disclosure may have the following key performance objectives.

Ultra-precision: The present disclosure may aim for advancement in selection and recognition of sensing target spaces/objects. The present disclosure may aim for high-resolution sensing and high-density data collection. The present disclosure may aim for enhancement of precision and accuracy of sensing results.

Low power consumption: As an example, the present disclosure may aim for optimization of sensing equipment and group selection. As another example, the present disclosure may aim for optimization of selection of sensing target spaces, objects, and times. As yet another example, the present disclosure may aim for optimization of interaction operations among applications, core networks, and devices.

Exemplary target performances of the present disclosure may provide optimal results in various application cases by simultaneously maximizing precision and efficiency of sensing data.

NFs and detailed functions for the core network 100 according to an exemplary embodiment of the present disclosure may be defined as shown in Table 2.

TABLE 2

| NF | Functional Block |
|---|---|
| SeCF | Sensing entities configuration |
| | Sensing entities policy management |
| | Sensing entities discovery/selection |
| SeMF | Sensing coordination/management |
| | Sensing method selection |
| | Sensing data collection/coordination |
| | Sensing data QoS management |
| SeRF | Sensing result calculation |
| | Sensing result verification |
| | Sensing result QoS management |
| SePF | Sensing service invocation |
| | Sensing service authorization |
| | Sensing service exposure |
| | Sensing security/privacy management |
| SDRF | Sensing data repository |
| NWDAF | Network Data Analytics Function |

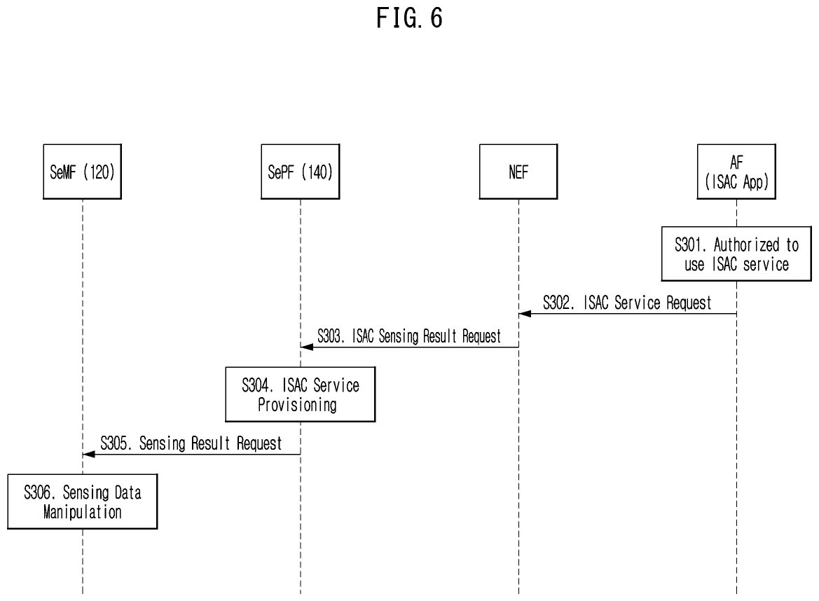

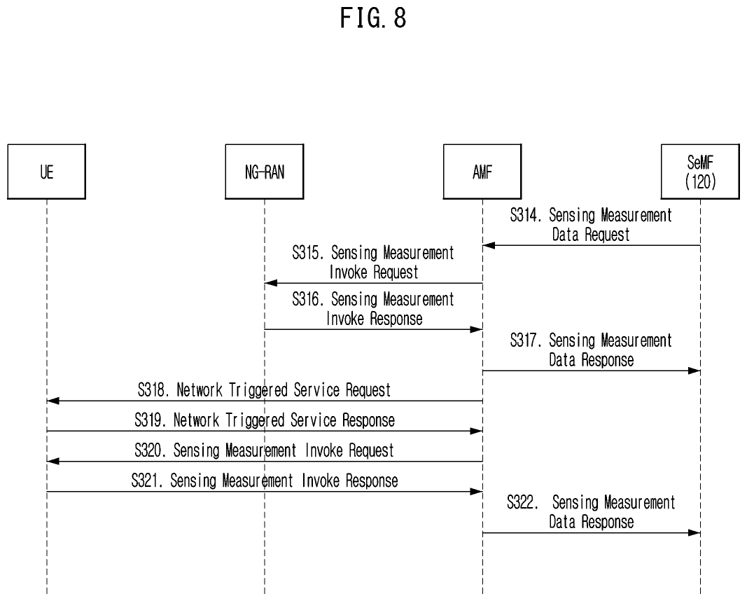

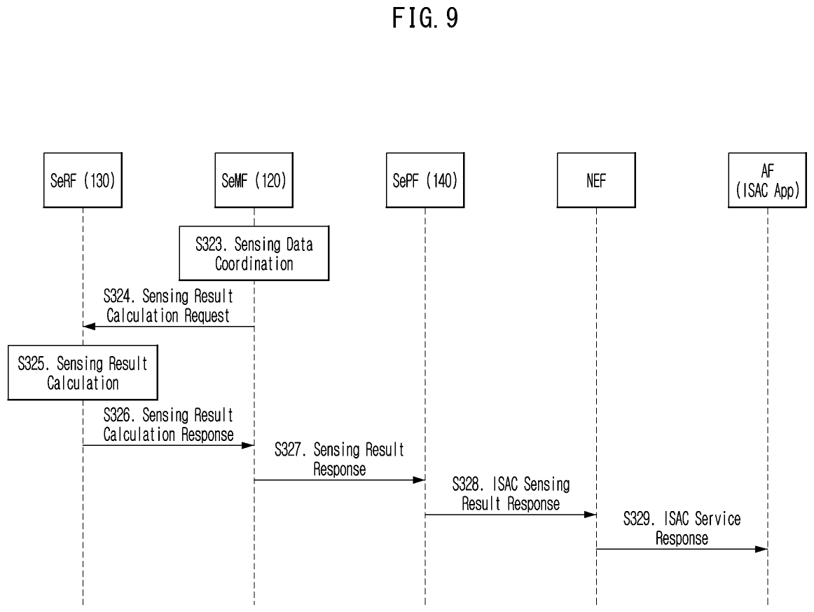

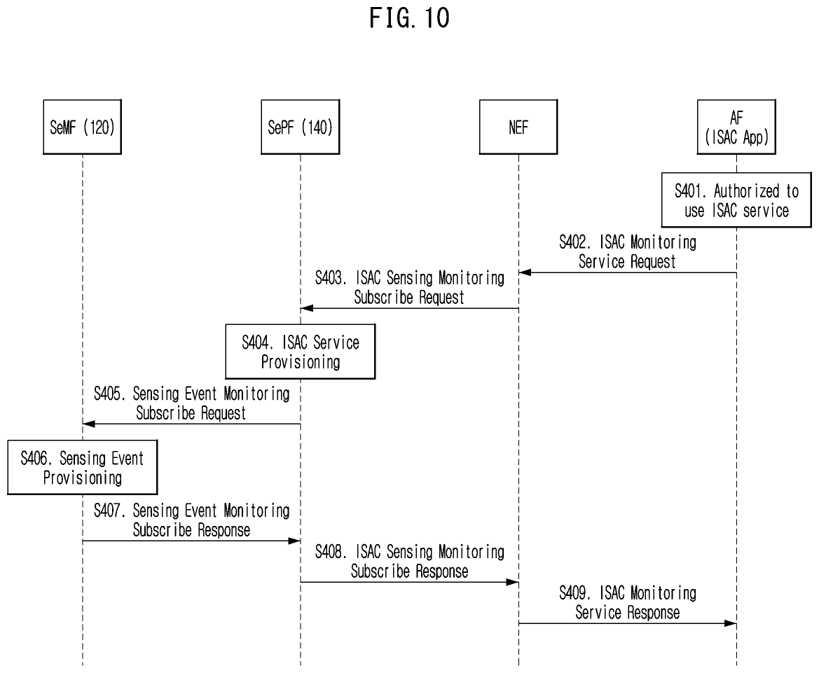

FIGS. 6 to 9 are operational flowcharts illustrating a sensing request procedure for a sensing method based on ISAC according to an exemplary embodiment of the present disclosure.

Referring to FIGS. 6 to 9, a sensing request procedure according to an exemplary embodiment of the present disclosure may correspond to a procedure for requesting and processing sensing data. The sensing request procedure according to an exemplary embodiment of the present disclosure may include steps of controlling, collecting, and calculating sensing data and providing a result of the sensing data.

A sensing request may be generated at the AF (e.g. ISAC App), and the SePF 140 may authenticate/authorize the sensing request in cooperation with the NEF and the AF (S301), and may receive the authorized service request and deliver the service request to the SeMF 120 (S302, S303, S304, S305). In this case, the SeMF 120 may perform manipulation as preprocessing for sensing data (S306). Step S306 may include a process of configuring sensing data required for processing the sensing request.

The SeMF 120 may deliver a sensing entity provisioning request as a sensing trigger to the SeCF 110 based on the sensing request (S307).

The SeCF 110 may discover and determine a sensing entity based on preconfigured sensing entity/sensing device configuration information (S308).

In this case, the SeCF 110 may request the UDM to discover a serving AMF corresponding to the sensing entity, if necessary (S309). The UDM may provide information on the serving AMF corresponding to the sensing entity in response to the request of step S309 (S310).

The SeCF 110 may transmit sensing entity configuration to the sensing entity (e.g. UE or NG-RAN) (S311, S312). Through steps S311 and S312, the SeCF 110 may configure and control the sensing entity and request sensing from the sensing entity. Through steps S311 and S312, the sensing entity may be prepared to perform sensing and may transmit a radio signal for sensing a target based on an instruction from the SeMF 120. In steps S311 and S312, when the sensing entity is in a state unsuitable for sensing, the SeCF 110 may determine another sensing entity and may perform steps S311 and S312 again.

The SeCF 110, after configuring the sensing entity, may provide configuration information for the sensing entity to the SeMF 120 (S313). Step S313 may be provided as a response to step S307.

The SeMF 120 may transmit a sensing request to the sensing entity (NG-RAN or UE) via the serving AMF and may receive sensing data (S314, S315, S316, S317, S318, S319, S320, S321, S322). The SeMF 120 may perform QoS-based preprocessing on the collected sensing data (S323).

The SeRF 130 may analyze and calculate the sensing data based on a request from the SeMF 120 (S324) and may generate a sensing result (S325, S326).

The SePF 140 may verify the sensing result delivered from the SeMF 120 (S327), and the SePF 140 may provide the verified sensing result to the AF, that is, the service that requested sensing, via the NEF (S328, S329).

The messages of the respective steps in the sensing request procedure illustrated in FIGS. 6 to 9 may illustratively include contents such as those shown in Table 3.

TABLE 3

| | Sending | Receiving | Function/Message | Input | |
|---|---|---|---|---|---|
| Step | NF | NF | Definition | parameters | Description |
| 1 | AF (ISAC | Internal | Authorized to use | User ID, | Confirmation of |
| | App) | processing | ISAC service | Request ID, | ISAC service |
| | | | | Request Type | authorization, and |
| | | | | | authentication of |
| | | | | | Request type |
| 2 | AF (ISAC | NEF | ISAC Service | AF ID, | Request for |
| | App) | | Request | Sensing Type, | sensing service |
| | | | | Sensing Target, | |
| | | | | Sensing Range | |
| 3 | NEF | SePF | ISAC Sensing | Sensing Target, | Management of |
| | | | Result Request | Request ID, | requested sensing |
| | | | | QoS | data, and request |
| | | | | Requirements, | for sensing result |
| | | | | Requested | |
| | | | | Result Type | |
| 4 | SePF | Internal | ISAC Service | Service | Perform internal |
| | | processing | Provisioning | Configuration | configuration tasks |
| | | | | Parameters, | |
| | | | | Network | |
| | | | | Resource | |
| | | | | Information, | |
| | | | | Policy Data | |
| 5 | SePF | SeMF | Sensing Result | Sensing Data | Request and |
| | | | Request | ID, | delivery of sensing |
| | | | | Transmission | data |
| | | | | Format, | |
| | | | | Sensing | |
| | | | | Metadata | |
| 6 | SeMF | Internal | Sensing Data | Stored sensing | Perform |
| | | processing | Manipulation | data(or | preprocessing of |
| | | | | historical | data |
| | | | | sensing data), | |
| | | | | Data | |
| | | | | Preprocessing | |
| | | | | Rules (may | |
| | | | | include Data | |
| | | | | analysis rules) | |
| 7 | SeMF | SeCF | Sensing Entity | Sensing | Request for |
| | | | Provisioning | Equipment ID, | configuring |
| | | | Request | Sensing | sensing equipment |
| | | | | Attributes, | |
| | | | | Configuration | |
| | | | | Parameters | |
| 8 | SeCF | Internal | Sensing Entity | Discovery | Discovery of |
| | | processing | Discovery | Parameters | available sensing |
| | | | | | equipment |
| 9 | SeCF | UDM | Serving AMF | Equipment | Request for |
| | | | Discovery request | Location | discovery of |
| | | | | Information, | appropriate AMF. |
| | | | | Sensing | |
| | | | | Service Type | |
| 10 | UDM | SeCF | Serving AMF | AMF Address | Delivery of |
| | | | Discovery | Information | discovered AMF |
| | | | response | | response |
| 11 | SeCF | NG-RAN | Sensing Entity | Configuration | Configuration of |
| | | | Configuration | Parameters, | base station |
| | | | | Control Policy | sensing equipment |
| 12 | SeCF | UE | Sensing Entity | Configuration | Configuration of |
| | | | Configuration | Parameters, | UE sensing |
| | | | | Control | equipment |
| | | | | Command | |
| 13 | SeCF | SeMF | Sensing Entity | Configuration | Reporting of |
| | | | Provisioning | Result | equipment |
| | | | response | | configuration |
| | | | | | status |
| 14 | SeMF | AMF | Sensing | UE ID, | Request for |
| | | | Measurement Data | Measurement | sensing data |
| | | | Request | Requirements, | measurement from |
| | | | | Data Range | NG-RAN and UE |
| 15 | AMF | NG-RAN | Sensing | UE ID, | Delivery of |
| | | | Measurement | Measurement | measurement |
| | | | Invoke request | Period, Target | request to NG- |
| | | | | Attributes | RAN |
| 16 | NG-RAN | AMF | Sensing | Response | Delivery of |
| | | | Measurement | Status, Result | measurement |
| | | | Invoke response | Metadata | operation result |
| 17 | AMF | SeMF | Sensing | Measurement | Delivery of data |
| | | | Measurement Data | Data, | from AMF |
| | | | Response | Transmission | |
| | | | | Status, Data | |
| | | | | Quality | |
| 18 | AMF | UE | Network Triggered | Service | Delivery of network |
| | | | Service Request | Request ID, | trigger request |
| | | | | Trigger | |
| | | | | Conditions | |
| 19 | UE | AMF | Network Triggered | Response | Response to |
| | | | Service Response | Status | network trigger |
| 20 | AMF | UE | Sensing | Measurement | Delivery of sensing |
| | | | Measurement | Attributes | request to UE |
| | | | Invoke request | | |
| 21 | UE | AMF | Sensing | Measurement | Delivery of sensing |
| | | | Measurement | Result, | result from UE |
| | | | Invoke response | Response | |
| | | | | Status | |
| 22 | AMF | SeMF | Sensing | Final | Delivery of final |
| | | | Measurement Data | Measurement | result from AMF |
| | | | Response | Data, QoS | |
| | | | | Status | |
| 23 | SeMF | Internal | Sensing Data | Preprocessed | Integration and |
| | | processing | Coordination | Data, | coordination of |
| | | | | Coordination | data |
| | | | | Parameters | |
| 24 | SeMF | SeRF | Sensing Result | Processed Data, | Request for result |
| | | | Calculation | Calculation | calculation |
| | | | Request | Requirements, | |
| | | | | Analysis | |
| | | | | Metadata | |
| 25 | SeRF | Internal | Sensing Result | Analysis Data, | Generation of |
| | | processing | Calculation | Analysis | results |
| | | | | Algorithm | |
| 26 | SeRF | SeMF | Sensing Result | Analysis | Delivery of |
| | | | Calculation | Result Data, | calculation results |
| | | | Response | Result Status | |
| 27 | SeMF | SePF | Sensing Result | Result Data, | Delivery of results |
| | | | Response | Status | to SePF |
| | | | | Information | |
| 28 | SePF | NEF | ISAC Sensing | Final Result, | Delivery of results |
| | | | Result Response | Request ID, | to NEF |
| | | | | QoS Metadata | |
| 29 | NEF | AF (ISAC | ISAC Service | Final Result | Delivery of results |
| | | App) | Response | Data, Service | to AF (ISAC App) |
| | | | | Status | |

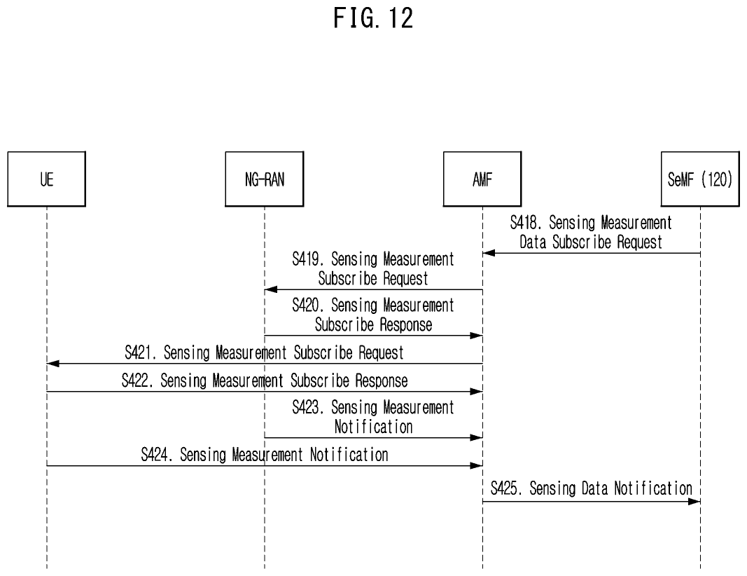

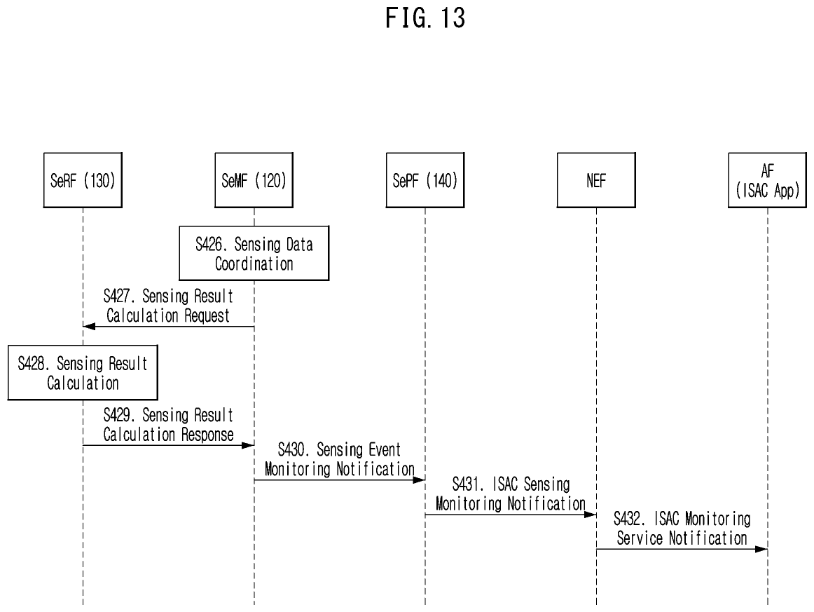

FIGS. 10 to 13 are operational flowcharts illustrating a sensing monitoring procedure for a sensing service provisioning method based on ISAC according to another exemplary embodiment of the present disclosure.

Referring to FIGS. 10 to 13, a sensing monitoring procedure according to an exemplary embodiment of the present disclosure may correspond to a procedure for monitoring a specific event and delivering a result. The sensing monitoring procedure according to an exemplary embodiment of the present disclosure, unlike the sensing request procedure illustrated in FIGS. 6 to 9, may be performed with a focus on collecting event-based monitoring data and providing the collected data to an application service.

A monitoring request including a specific event condition may delivered from the AF (e.g. ISAC App), and the SePF 140 may authenticate/authorize the sensing request in cooperation with the NEF and the AF (S401), and may receive the authorized service request and deliver the service request to the SeMF 120 (S402, S403, S404, S405). In this case, the SePF 140 may define, set, and/or plan related operations based on the monitoring request (S404).

In this case, the SeMF 120 may perform provisioning as preprocessing for a sensing event (S406). In steps S407, S408, and S409, a response delivered to the AF may include an acceptance of the monitoring request by the SeMF 120 or the SePF 140.

In this case, the SeMF 120 may perform manipulation as preprocessing for sensing data (S410). Step S410 may include a process of configuring sensing data required for processing the sensing monitoring request or the sensing event.

The SeMF 120 may deliver a sensing entity provisioning request as a sensing trigger to the SeCF 110 based on the sensing monitoring request or the sensing event (S411).

The SeCF 110 may discover and determine a sensing entity based on preconfigured sensing entity/sensing device configuration information (S412).

In this case, the SeCF 110 may request the UDM to discover a serving AMF corresponding to the sensing entity, if necessary (S413). The UDM may provide information on the serving AMF corresponding to the sensing entity in response to the request of S413 (S414).

The SeCF 110 may transmit sensing entity configuration to the sensing entity (e.g. UE or NG-RAN) (S415, S416). Through steps S415 and S416, the SeCF 110 may configure and control the sensing entity and request sensing from the sensing entity. Through steps S415 and S416, the sensing entity may be prepared to perform sensing and may transmit a radio signal for sensing a target based on an instruction from the SeMF 120. In steps S415 and S416, when the sensing entity is in a state unsuitable for sensing, the SeCF 110 may determine another sensing entity and may perform steps S415 and S416 again.

The SeCF 110, after configuring the sensing entity, may provide configuration information for the sensing entity to the SeMF 120 (S417). Step S417 may be provided as a response to step S411.

The SeMF 120 may transmit a sensing request to the sensing entity (e.g. NG-RAN or UE) via the serving AMF and may receive sensing data (S418, S419, S420, S421, S422, S423, S424, S425). The SeMF 120 may perform QoS-based preprocessing on the collected sensing data (S426).

The SeRF 130 may analyze and calculate the sensing data based on a request from the SeMF 120 (S427) and may generate a sensing result (S428, S429).

The SePF 140 may verify the sensing result delivered from the SeMF 120 (S430), and the SePF 140 may provide the verified sensing result to the AF, that is, the service that requested sensing, via the NEF (S431, S432).

In this case, the sensing data may be provided from the sensing entity (e.g. UE or NG-RAN) when the event condition included in the sensing monitoring request is satisfied. Alternatively, the sensing result associated with the event condition may be generated through filtering, calculation, or processing by the SeMF 120 and/or the SeRF 130.

The messages of the respective steps in the sensing monitoring procedure illustrated in FIGS. 10 to 13 may illustratively include contents such as those shown in Table 4.

TABLE 4

| | Sending | Receiving | Function/Message | Input | |
|---|---|---|---|---|---|
| Step | NF | NF | Definition | parameters | Description |
| 1 | AF | Internal | Authorized to use | User ID, | Confirmation of |
| | (ISAC | processing | ISAC service | Request ID, | ISAC service |
| | App) | | | Request Type | authorization, |
| | | | | | and |
| | | | | | authentication |
| | | | | | of Request |
| | | | | | Type |
| 2 | AF | NEF | ISAC Monitoring | AF ID, Sensing | Request for |
| | (ISAC | | Service Request | Type, Sensing | sensing |
| | App) | | | Target, Sensing | monitoring |
| | | | | Range | service |
| 3 | NEF | SePF | ISAC Sensing | Sensing Target, | Requested |
| | | | Monitoring | Request ID, QoS | sensing |
| | | | Subscribe Request | Requirements, | monitoring |
| | | | | Requested | subscription |
| | | | | Result Type | request |
| 4 | SePF | Internal | ISAC Service | Service | Perform |
| | | processing | Provisioning | Configuration | internal |
| | | | | Parameters, | configuration |
| | | | | Network | tasks |
| | | | | Resource | |
| | | | | Information, | |
| | | | | Policy Data | |
| 5 | SePF | SeMF | Sensing Event | Sensing Data ID, | Request for |
| | | | Monitoring | Transmission | sensing event |
| | | | Subscribe Request | Format, Sensing | monitoring |
| | | | | Metadata | subscription |
| 6 | SeMF | Internal | Sensing Event | Service Policy, | Perform |
| | | processing | Provisioning | Event | internal |
| | | | | Parameters | configuration |
| | | | | | tasks for |
| | | | | | sensing events |
| 7 | SeMF | SePF | Sensing Event | Result Status, | Response to |
| | | | Monitoring | Confirmation | sensing event |
| | | | Subscribe | Data | monitoring |
| | | | Response | | subscription |
| | | | | | request |
| 8 | SePF | NEF | ISAC Sensing | Status | Response to |
| | | | Monitoring | Information, | sensing |
| | | | Subscribe | Request ID | monitoring |
| | | | Response | | subscription |
| | | | | | request |
| 9 | NEF | AF (ISAC | ISAC Monitoring | Status Data, | Response to |
| | | App) | Service Response | Response Code | sensing |
| | | | | | monitoring |
| | | | | | service request |
| 10 | SeMF | Internal | Sensing Data | Stored sensing | Perform data |
| | | processing | Manipulation | data(or historical | preprocessing |
| | | | | sensing data), | |
| | | | | Data | |
| | | | | Preprocessing | |
| | | | | Rules (may | |
| | | | | include Data | |
| | | | | analysis rules) | |
| 11 | SeMF | SeCF | Sensing Entity | Sensing | Request for |
| | | | Provisioning | Equipment ID, | configuring |
| | | | Request | Sensing | sensing |
| | | | | Attributes, | equipment |
| | | | | Configuration | |
| | | | | Parameters | |
| 12 | SeCF | Internal | Sensing Entity | Discovery | Discovery of |
| | | processing | Discovery | Parameters | available |
| | | | | | sensing |
| | | | | | equipment |
| 13 | SeCF | UDM | Serving AMF | Equipment | Request for |
| | | | Discovery request | Location | discovering an |
| | | | | Information, | appropriate |
| | | | | Sensing Service | AMF |
| | | | | Type | |
| 14 | UDM | SeCF | Serving AMF | AMF Address | Delivery of |
| | | | Discovery response | Information | discovered |
| | | | | | AMF response |
| 15 | SeCF | NG-RAN | Sensing Entity | Configuration | Configuration |
| | | | Configuration | Parameters, | of base station |
| | | | | Control Policy | sensing |
| | | | | | equipment for |
| | | | | | monitoring |
| 16 | SeCF | UE | Sensing Entity | Configuration | Configuration |
| | | | Configuration | Parameters, | of UE sensing |
| | | | | Control | equipment for |
| | | | | Commands | monitoring |
| 17 | SeCF | SeMF | Sensing Entity | Configuration | Reporting of |
| | | | Provisioning | Result | equipment |
| | | | response | | configuration |
| | | | | | status |
| 18 | SeMF | AMF | Sensing | Measurement | Request for |
| | | | Measurement Data | Subscription | sensing |
| | | | Subscribe Request | Request | measurement |
| | | | | Parameters | data |
| | | | | | subscription |
| 19 | AMF | NG-RAN | Sensing | UE ID, | Request for |
| | | | Measurement | Measurement | sensing |
| | | | Subscribe Request | Period, Target | measurement |
| | | | | Attributes | data monitoring |
| | | | | | subscription to |
| | | | | | NG-RAN |
| 20 | NG-RAN | AMF | Sensing | Response | Response to |
| | | | Measurement | Status, Result | sensing |
| | | | Subscribe | Metadata | measurement |
| | | | Response | | data monitoring |
| | | | | | subscription |
| | | | | | request |
| 21 | AMF | UE | Sensing | UE ID, | Request for |
| | | | Measurement | Measurement | sensing |
| | | | Subscribe Request | Period, Target | measurement |
| | | | | Attributes | data monitoring |
| | | | | | subscription to |
| | | | | | UE |
| 22 | UE | AMF | Sensing | Response | Response to |
| | | | Measurement | Status, Result | sensing |
| | | | Subscribe | Metadata | measurement |
| | | | Response | | data monitoring |
| | | | | | subscription |
| | | | | | request |
| 23 | NG-RAN | AMF | Sensing | Measurement | Sensing data |
| | | | Measurement | Data, Status | notification |
| | | | Notification | Information | from NG-RAN |
| 24 | UE | AMF | Sensing | Measurement | Sensing data |
| | | | Measurement | Data, Status | notification |
| | | | Notification | Information | from UE |
| 25 | AMF | SeMF | Sensing Data | Final | Sensing data |
| | | | Notification | Measurement | notification |
| | | | | Data, QoS | from AMF |
| | | | | Status | |
| 26 | SeMF | Internal | Sensing Data | Preprocessed | Data |
| | | processing | Coordination | Data, | integration and |
| | | | | Coordination | coordination |
| | | | | Parameters | |
| 27 | SeMF | SeRF | Sensing Result | Processed Data, | Request for |
| | | | Calculation Request | Calculation | sensing result |
| | | | | Requirements, | calculation |
| | | | | Analysis | |
| | | | | Metadata | |
| 28 | SeRF | Internal | Sensing Result | Analysis Data, | Generation of |
| | | processing | Calculation | Analysis | results |
| | | | | Algorithm | |
| 29 | SeRF | SeMF | Sensing Result | Analysis Result | Delivery of |
| | | | Calculation | Data, Result | calculation |
| | | | Response | Status | result |
| 30 | SeMF | SePF | Sensing Event | Result Data, | Sensing event |
| | | | Monitoring | Status | notification to |
| | | | Notification | Information | SePF |
| 31 | SePF | NEF | ISAC Sensing | Final Result, | Sensing event |
| | | | Monitoring | Request ID, QoS | notification to |
| | | | Notification | Metadata | NEF |
| 32 | NEF | AF (ISAC | ISAC Monitoring | Final Result | Sensing event |
| | | App) | Service Notification | Data, Service | notification to |
| | | | | Status | AF (ISAC App) |

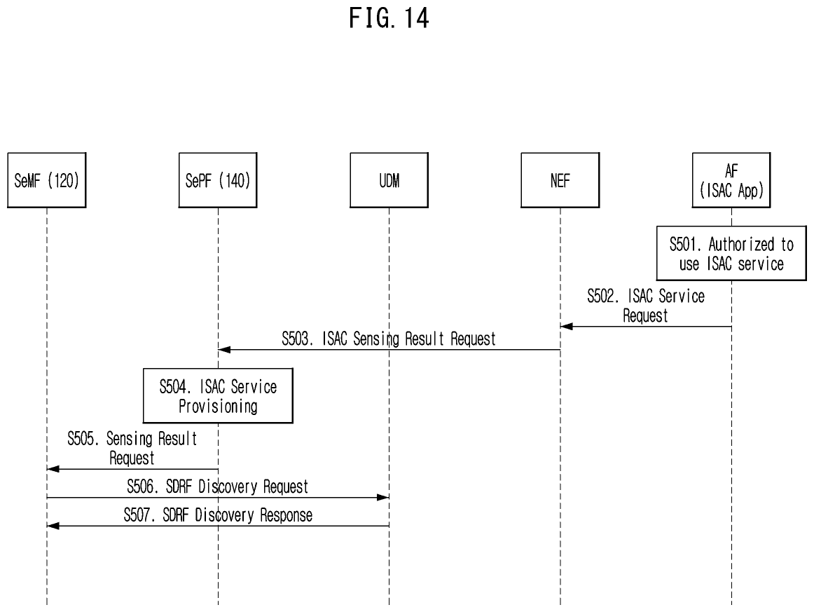

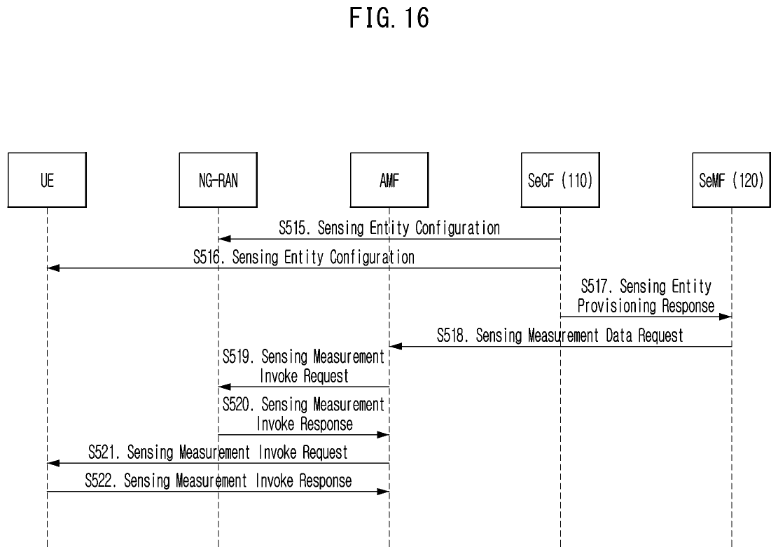

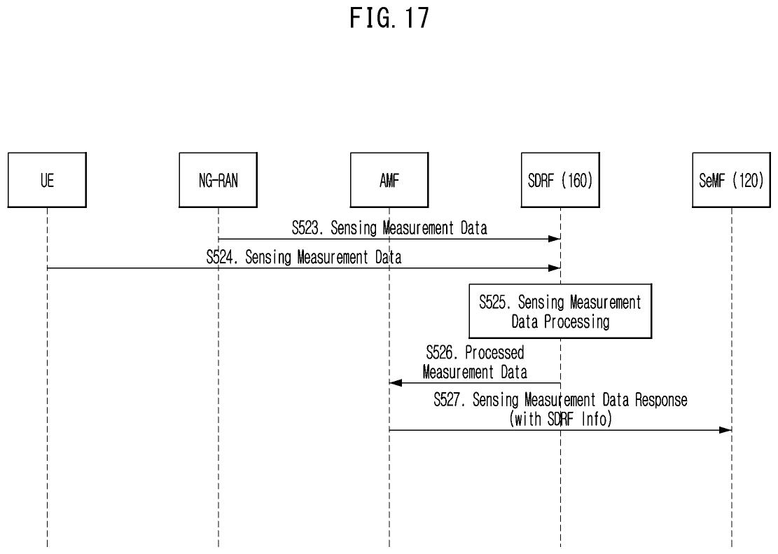

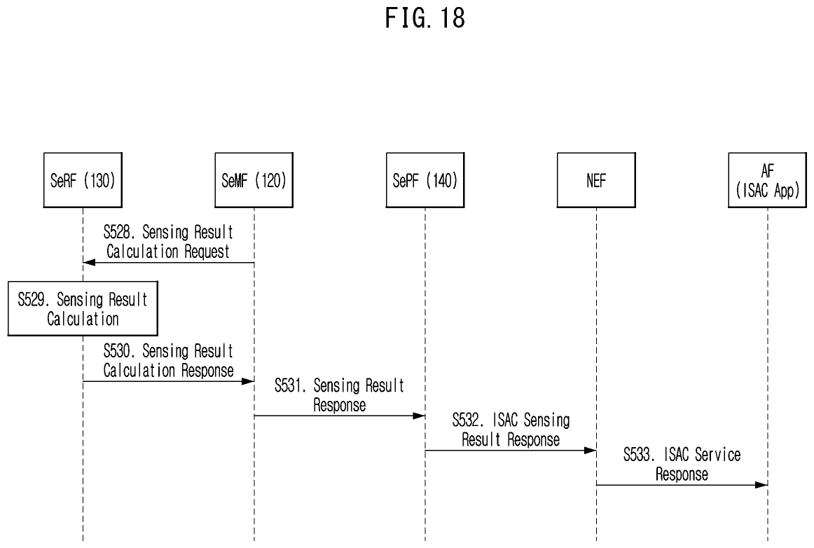

FIGS. 14 to 18 are operational flowcharts illustrating a sensing request process for a sensing method based on ISAC according to another exemplary embodiment of the present disclosure.

Referring to FIGS. 14 to 18, a sensing request procedure for the core network 100 including the SDRF 160 according to an exemplary embodiment of the present disclosure is illustrated. The sensing request procedure using the SDRF 160 according to an exemplary embodiment of the present disclosure may correspond to a procedure for processing data based on QoS through integrated management of distributedly stored data in the localized SDRF 160. The SDRF 160 may localized and collects data from the NG-RAN and UEs, and may enhance the efficiency of sensing results by retrieving, processing, and transmitting the collected data.

In the exemplary embodiments of FIGS. 14 to 18, descriptions of operations redundant with the exemplary embodiments of FIGS. 6 to 9 are omitted, and the description focuses on the configuration related to the SDRF 160.

After discovering the location and presence of the SDRF 160, the SeMF 120 may may request data from the SDRF 160 (S508, S509). In this case, the SeMF 120 may receive assistance from the UDM to discover the location and presence of the SDRF 160 (S506, S507).

The SeMF 120 may transmit a sensing trigger to the SeCF 110 (S511) and may receive feedback regarding a result of setting and configuring the sensing entity (S517). In this case, information on the SDRF 160 may be shared in the sensing trigger. The sensing entity (e.g. NG-RAN and/or UE) may transmit sensing data to the SDRF 160 (S523, S524).

In this case, in steps S523 and S524, the sensing entity (e.g. NG-RAN and/or UE) may transmit sensing data to the SDRF 160 based on the information on the SDRF 160 shared in the sensing trigger, or may transmit the sensing data to the SDRF 160 based on configuration information previously possessed by the sensing entity.

The SDRF 160 may retrieve and select appropriate data based on QoS criteria among the received sensing data (S525) and may transmit the selected data to the SeMF 120 via the AMF (S526, S527). In this case, the AMF may transmit the sensing data together with information on the SDRF 160 in step S527.

According to an alternative exemplary embodiment of the present disclosure, the SDRF 160 may provide data to the SeMF 120 or the SeRF 130 so that a sensing result can be generated.

Based on the cooperation of the SeMF 120, the SeRF 130, and/or the SePF 140, the sensing result may be provided to the AF via the NEF.

The messages of the respective steps in the sensing request procedure using the SDRF 160 illustrated in FIGS. 14 to 18 may illustratively include contents as shown in Table 5.

TABLE 5

| | Sending | Receiving | Function/Message | Input | |
|---|---|---|---|---|---|
| Step | NF | NF | Definition | parameters | Description |
| 1 | AF | Internal | Authorized to use | User ID, | Confirmation of |
| | (ISAC | processing | ISAC service | Request ID, | ISAC service |
| | App) | | | Request Type | authorization, and |
| | | | | | authentication of |
| | | | | | Request Type |
| 2 | AF | NEF | ISAC Service | AF ID, Sensing | Request for |
| | (ISAC | | Request | Type, Sensing | sensing service |
| | App) | | | Target, | |
| | | | | Sensing Range | |
| 3 | NEF | SePF | ISAC Sensing | Sensing | Request for |
| | | | Result Request | Target, | sensing data |
| | | | | Request ID, | management and |
| | | | | QoS | result request |
| | | | | Requirements, | |
| | | | | Requested | |
| | | | | Result Type | |
| 4 | SePF | Internal | ISAC Service | Service | Perform internal |
| | | processing | Provisioning | Configuration | configuration tasks |
| | | | | Parameters, | |
| | | | | Network | |
| | | | | Resource | |
| | | | | Information, | |
| | | | | Policy Data | |
| 5 | SePF | SeMF | Sensing Result | Sensing Data | Request and |
| | | | Request | ID, | delivery of sensing |
| | | | | Transmission | data |
| | | | | Format, | |
| | | | | Sensing | |
| | | | | Metadata | |
| 6 | SeMF | UDM | SDRF Discovery | SDRF Location | Request to |
| | | | Request | Information, | discover the |
| | | | | QoS | location of the |
| | | | | Requirements | SDRF |
| 7 | UDM | SeMF | SDRF Discovery | SDRF Address | Response with |
| | | | Response | Information | SDRF location |
| | | | | | information |
| 8 | SeMF | SDRF | Sensing Data | Data Index, | Request to retrieve |
| | | | Query | QoS | relevant sensing |
| | | | | Requirements, | data from the |
| | | | | Location | SDRF |
| | | | | Information | |
| 9 | SDRF | SeMF | Sensing Data | Retrieved Data, | Response with |
| | | | Response | QoS | relevant sensing |
| | | | | Information | data stored in the |
| | | | | | SDRF |
| 10 | SeMF | Internal | Sensing Data | Retrieved Data, | Perform data |
| | | processing | Manipulation | Stored sensing | preprocessing |
| | | | | data(or | based data |
| | | | | historical | received from the |
| | | | | sensing data), | SDRF |
| | | | | Data | |
| | | | | Preprocessing | |
| | | | | Rules (may | |
| | | | | include Data | |
| | | | | analysis rules) | |
| 11 | SeMF | SeCF | Sensing Entity | Sensing | Request for |
| | | | Provisioning | Equipment ID, | configuring |
| | | | Request | Sensing | sensing equipment |
| | | | | Attributes, | |
| | | | | Configuration | |
| | | | | Parameters | |
| 12 | SeCF | Internal | Sensing Entity | Discovery | Discovery of |
| | | processing | Discovery | Parameters | available sensing |
| | | | | | equipment |
| 13 | SeCF | UDM | Serving AMF | Equipment | Request for |
| | | | Discovery request | Location | discovering the |
| | | | | Information, | AMF governing the |
| | | | | Sensing | discovered |
| | | | | Service Type | sensing equipment |
| 14 | UDM | SeCF | Serving AMF | AMF Address | Delivery of |
| | | | Discovery response | Information | discovered AMF |
| | | | | | response |
| 15 | SeCF | NG-RAN | Sensing Entity | Configuration | Configuration of |
| | | | Configuration | Parameters, | base station |
| | | | | Control Policy | sensing equipment |
| 16 | SeCF | UE | Sensing Entity | Configuration | Configuration of |
| | | | Configuration | Parameters, | UE sensing |
| | | | | Control | equipment |
| | | | | Commands | |
| 17 | SeCF | SeMF | Sensing Entity | Configuration | Reporting of |
| | | | Provisioning | Result | equipment |
| | | | Response | | configuration |
| | | | | | status |
| 18 | SeMF | AMF | Sensing | UE ID, | Request for |
| | | | Measurement Data | Measurement | measurement data |
| | | | Request | Requirements, | from the UE |
| | | | | Data Range | |
| 19 | AMF | NG-RAN | Sensing | UE ID, | Delivery of |
| | | | Measurement | Measurement | measurement |
| | | | Invoke Request | Period, Target | request to the NG- |
| | | | | Attributes | RAN |
| 20 | NG-RAN | AMF | Sensing | Response | Delivery of |
| | | | Measurement | Status, Result | measurement task |
| | | | Invoke Response | Metadata | result from the NG- |
| | | | | | RAN |
| 21 | AMF | UE | Sensing | Measurement | Delivery of sensing |
| | | | Measurement | Attributes | request to the UE |
| | | | Invoke Request | | |
| 22 | UE | AMF | Sensing | Measurement | Delivery of sensing |
| | | | Measurement | Result, | result from the UE |
| | | | Invoke Response | Response | |
| | | | | Status | |
| 23 | NG-RAN | SDRF | Sensing | Measurement | Delivery of data |
| | | | Measurement Data | Data, QoS | from the NG-RAN |
| | | | | Information | to the SDRF |
| 24 | UE | SDRF | Sensing | Measurement | Delivery of data |
| | | | Measurement Data | Data, QoS | from the UE to the |
| | | | | Information | SDRF |
| 25 | SDRF | Internal | Sensing | Measurement | Storage of data |
| | | processing | Measurement Data | Data, | and distributed |
| | | | Processing | Distributed | processing into |
| | | | | Processing | localized storage |
| | | | | Policy | |
| 26 | SDRF | AMF | Processed | Processed | Delivery of |
| | | | Measurement Data | Data, QoS | processed data |
| | | | | Information | from the SDRF to |
| | | | | | the AMF |
| 27 | AMF | SeMF | Sensing | Final | Delivery of sensing |
| | | | Measurement Data | Measurement | data from the AMF |
| | | | Response | Data, QoS | to the SeMF |
| | | | | Status | |
| 28 | SeMF | SeRF | Sensing Result | Processed | Request for result |
| | | | Calculation | Data, | calculation |
| | | | Request | Calculation | |
| | | | | Requirements, | |
| | | | | Analysis | |
| | | | | Metadata | |
| 29 | SeRF | Internal | Sensing Result | Analysis Data, | Generation of |
| | | processing | Calculation | Analysis | result |
| | | | | Algorithm | |
| 30 | SeRF | SeMF | Sensing Result | Analysis Result | Delivery of |
| | | | Calculation | Data, Result | calculation result |
| | | | Response | Status | |
| 31 | SeMF | SePF | Sensing Result | Result Data, | Delivery of result to |
| | | | Response | Status | the SePF |
| | | | | Information | |
| 32 | SePF | NEF | ISAC Sensing | Final Result, | Delivery of result to |
| | | | Result Response | Request ID, | the NEF |
| | | | | QoS Metadata | |
| 33 | NEF | AF (ISAC | ISAC Service | Final Result | Delivery of result to |
| | | App) | Response | Data, Service | the AF (ISAC App) |
| | | | | Status | |

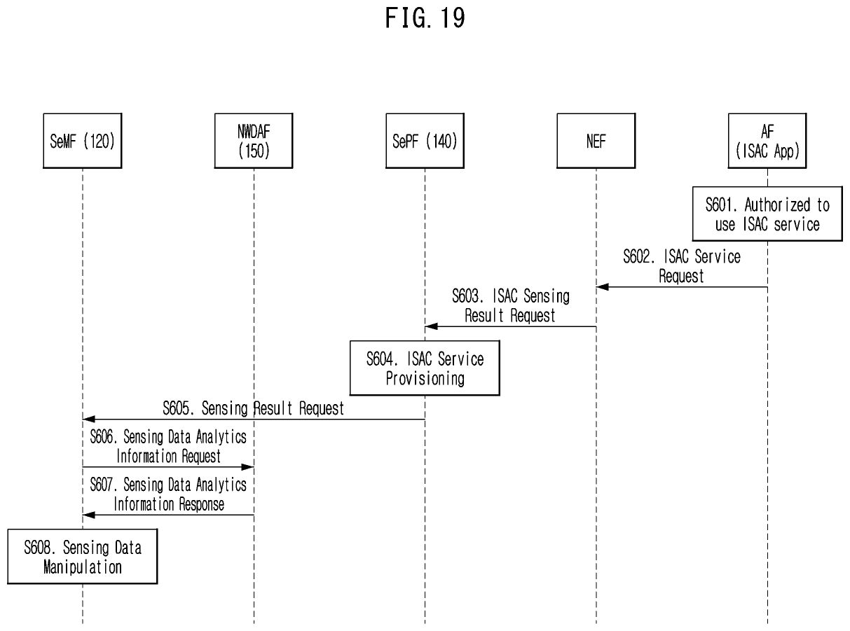

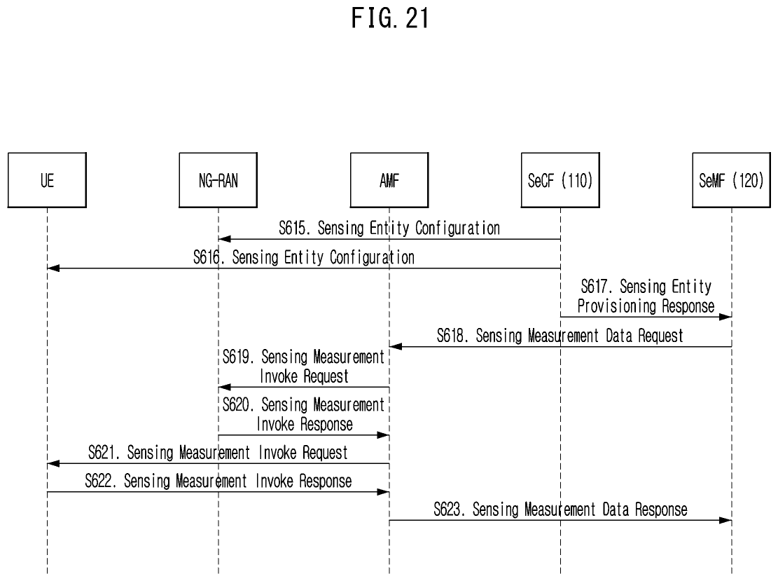

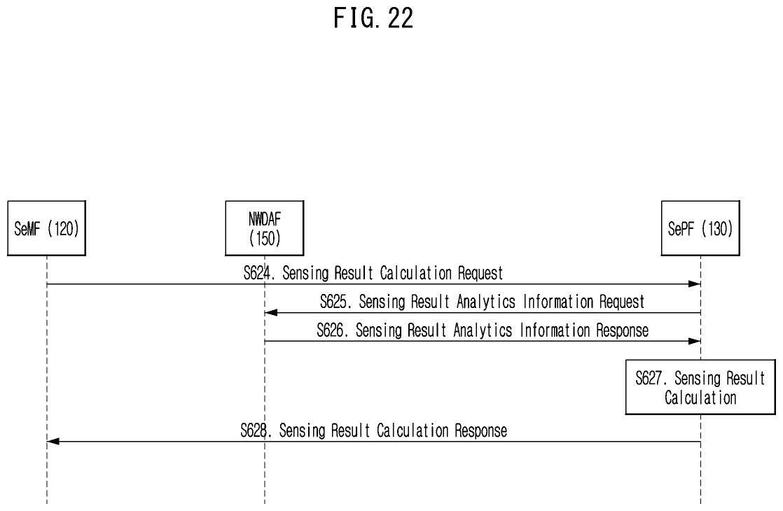

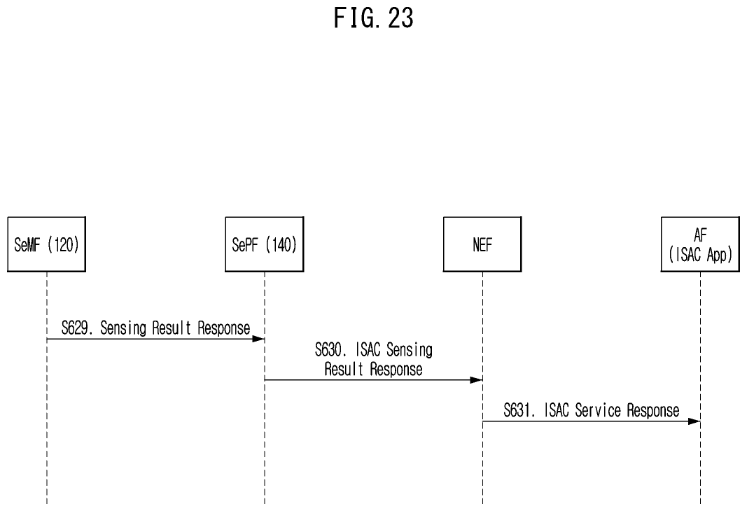

FIGS. 19 to 23 are operational flowcharts illustrating a sensing request process for a sensing method based on ISAC according to another exemplary embodiment of the present disclosure.

An AI-enhanced sensing request procedure using the NWDAF 150 illustrated in FIGS. 19 to 23 may perform preprocessing, result calculation, and sensing device configuration optimization by using AI-based data analysis and optimization through interaction with the NWDAF 150. The NWDAF 150 may enhance the efficiency of data preprocessing and result calculation by providing analysis information to the SeMF 120 and the SeRF 130, and may optimize the sensing device configuration by supporting the SeCF 110.

In the exemplary embodiments of FIGS. 19 to 23, descriptions of operations redundant with the exemplary embodiments of FIGS. 6 to 9 are omitted, and the description focuses on the configuration related to the NWDAF 150.

Preprocessing optimization: The SeMF 120 may transmit a data preprocessing support request to the NWDAF 150 (S606) and may perform preprocessing based on an analysis result received from the NWDAF 150 (S607, S608) Sensing equipment/device configuration optimization: The SeCF 110 may optimize the configuration of the sensing entity based on the analysis result of the NWDAF 150 (S613, S614).

Sensing result calculation optimization: The SeRF 130 may enhance the efficiency and accuracy of result calculation by utilizing the assistance information from the NWDAF 150 (S625, S626, S627).

The sensing request procedure including AI-based analysis may optimize data preprocessing, equipment configuration, and result calculation with the assistance of the NWDAF (150).

The messages of the respective steps in the AI-enhanced sensing request procedure using the NWDAF 150 illustrated in FIGS. 19 to 23 may illustratively include contents as shown in Table 6.

TABLE 6

| | Sending | Receiving | Function/Message | Input | |
|---|---|---|---|---|---|
| Step | NF | NF | Definition | parameters | Description |
| 1 | AF (ISAC | Internal | Authorized to use | User ID, | Confirmation |
| | App) | processing | ISAC service | Request ID, | of ISAC |
| | | | | Request Type | service |
| | | | | | authorization, |
| | | | | | and |
| | | | | | authentication |
| | | | | | of Request |
| | | | | | Type |
| 2 | AF (ISAC | NEF | ISAC Service Request | AF ID, Sensing | |
| | App) | | | Type, Sensing | |
| | | | | Target, | |
| | | | | Sensing Range | |
| 3 | NEF | SePF | ISAC Sensing Result | Sensing | Request for |
| | | | Request | Target, | requested |
| | | | | Request ID, | sensing data |
| | | | | QoS | management |
| | | | | Requirements, | and result |
| | | | | Requested | request |
| | | | | Result Type | |
| 4 | SePF | Internal | ISAC Service | Service | Perform |
| | | processing | Provisioning | Configuration | internal |
| | | | | Parameters, | configuration |
| | | | | Network | tasks |
| | | | | Resource | |
| | | | | Information, | |
| | | | | Policy Data | |
| 5 | SePF | SeMF | Sensing Result | Sensing Data | Request and |
| | | | Request | ID, | delivery of |
| | | | | Transmission | sensing data |
| | | | | Format, | |
| | | | | Sensing | |
| | | | | Metadata | |
| 6 | SeMF | NWDAF | Sensing Data | Data | Request for |
| | | | Analytics Information | Preprocessing | NWDAF |
| | | | Request | Requirements, | support for |
| | | | | QoS | data |
| | | | | Information | preprocessing |
| | | | | | efficiency |
| 7 | NWDAF | SeMF | Sensing Data | Optimized Data | Delivery of |
| | | | Analytics Information | Processing | data |
| | | | Response | Rules, QoS | preprocessing |
| | | | | Improvement | efficiency |
| | | | | Information | information |
| | | | | | based on |
| | | | | | NWDAF |
| | | | | | analysis |
| | | | | | results |
| 8 | SeMF | Internal | Sensing Data | Stored sensing | Perform data |
| | | processing | Manipulation | data(or | preprocessing |
| | | | | historical | by utilizing |
| | | | | sensing data), | support |
| | | | | Data | information |
| | | | | Preprocessing | from NWDAF |
| | | | | Rules (may | |
| | | | | include Data | |
| | | | | analysis rules) | |
| 9 | SeMF | SeCF | Sensing Entity | Sensing | Request for |
| | | | Provisioning Request | Equipment ID, | configuring |
| | | | | Sensing | sensing |
| | | | | Attributes, | equipment |
| | | | | Configuration | |
| | | | | Parameters | |
| 10 | SeCF | Internal | Sensing Entity | Discovery | Discovery of |
| | | processing | Discovery | Parameters | available |
| | | | | | sensing |
| | | | | | equipment |
| 11 | SeCF | UDM | Serving AMF | Equipment | Request for |
| | | | Discovery Request | Location | discovering |
| | | | | Information, | the AMF |
| | | | | Sensing | governing the |
| | | | | | discovered |
| | | | | Service Type | sensing |
| | | | | | equipment |
| 12 | UDM | SeCF | Serving AMF | AMF Address | Delivery of |
| | | | Discovery Response | Information | discovered |
| | | | | | AMF |
| | | | | | response |
| 13 | SeCF | NWDAF | Sensing Entity | Sensing | Request for |
| | | | Analytics Information | Equipment | NWDAF |
| | | | Request | Configuration | support for |
| | | | | Optimization | sensing |
| | | | | Request, QoS | equipment |
| | | | | Metadata | configuration |
| | | | | | optimization |
| 14 | NWDAF | SeCF | Sensing Entity | Optimized | Provision of |
| | | | Analytics Information | Configuration | optimized |
| | | | Response | Values, | configuration |
| | | | | Analysis | values |
| | | | | Results | through Al |
| | | | | | analysis |
| 15 | SeCF | NG-RAN | Sensing Entity | Configuration | Configuration |
| | | | Configuration | Parameters, | of base |
| | | | | Control Policy | station |
| | | | | | sensing |
| | | | | | equipment |
| 16 | SeCF | UE | Sensing Entity | Configuration | Configuration |
| | | | Configuration | Parameters, | of UE sensing |
| | | | | Control | equipment |
| | | | | Commands | |
| 17 | SeCF | SeMF | Sensing Entity | Configuration | Reporting of |
| | | | Provisioning | Result | equipment |
| | | | Response | | configuration |
| | | | | | status |
| 18 | SeMF | AMF | Sensing | UE ID, | Request for |
| | | | Measurement Data | Measurement | measurement |
| | | | Request | Requirements, | data from the |
| | | | | Data Range | UE |
| 19 | AMF | NG-RAN | Sensing | UE ID, | Delivery of |
| | | | Measurement Invoke | Measurement | measurement |
| | | | Request | Period, Target | request to the |
| | | | | Attributes | NG-RAN |
| 20 | NG-RAN | AMF | Sensing | Response | Delivery of |
| | | | Measurement Invoke | Status, Result | measurement |
| | | | Response | Metadata | task result |
| | | | | | from the NG- |
| | | | | | RAN |
| 21 | AMF | UE | Sensing | Measurement | Delivery of |
| | | | Measurement Invoke | Attributes | sensing |
| | | | Request | | request to the |
| | | | | | UE |
| 22 | UE | AMF | Sensing | Measurement | Delivery of |
| | | | Measurement Invoke | Result, | sensing result |
| | | | Response | Response | from the UE |
| | | | | Status | |
| 23 | AMF | SeMF | Sensing | Measurement | Delivery of |
| | | | Measurement Data | Data, QoS | sensing data |
| | | | Response | Status | from the AMF |
| | | | | | to the SeMF |
| 24 | SeMF | SeRF | Sensing Result | Processed | Request for |
| | | | Calculation Request | Data, | result |
| | | | | Calculation | calculation |
| | | | | Requirements, | |
| | | | | Analysis | |
| | | | | Metadata | |
| 25 | SeRF | NWDAF | Sensing Result | Result | Request for |
| | | | Analytics Information | Calculation | NWDAF |
| | | | Request | Optimization | support for |
| | | | | Request, QoS | result |
| | | | | Information | calculation |
| | | | | | efficiency |
| 26 | NWDAF | SeRF | Sensing Result | Analysis | Provision of |
| | | | Analytics Information | Result, | optimized |
| | | | Response | Optimized | calculation |
| | | | | Calculation | result through |
| | | | | Values | Al analysis |
| 27 | SeRF | Internal | Sensing Result | Analysis Data, | Perform result |
| | | processing | Calculation | Analysis | calculation by |
| | | | | Algorithm | utilizing |
| | | | | | support |
| | | | | | information |
| | | | | | from NWDAF |
| 28 | SeRF | SeMF | Sensing Result | Analysis Result | Delivery of |
| | | | Calculation Response | Data, Result | calculation |
| | | | | Status | result |
| 29 | SeMF | SePF | Sensing Result | Result Data, | Delivery of |
| | | | Response | Status | result to the |
| | | | | Information | SePF |
| 30 | SePF | NEF | ISAC Sensing Result | Final Result, | Delivery of |
| | | | Response | Request ID, | result to the |
| | | | | QoS Metadata | NEF |
| 31 | NEF | AF (ISAC | ISAC Service | Final Result | Delivery of |
| | | App) | Response | Data, Service | result to the |
| | | | | Status | AF (ISAC |
| | | | | | App) |

Referring again to FIGS. 6 to 9, input parameters used in the respective steps of the sensing request procedure according to an exemplary embodiment of the present disclosure may be defined as shown in Table 7.

TABLE 7

| No. | Parameter | Description | Usage and Example |
|---|---|---|---|
| 1 | User ID | Globally unique identifier for | Verification of the appropriateness |
| | | uniquely identifying the service | of the ISAC service request and |
| | | requester | session management |
| 2 | Request ID | Timestamp-based ID for | Prevention of duplicate requests, |
| | | uniquely identifying each | session tracking, and logging |
| | | request | |
| 3 | Service | Service type specification | Selection of appropriate operation |
| | Request Type | (environment sensing, location | processes and resource |
| | | sensing, detection, tracking) | allocation for each service |
| 4 | AF ID | Unique ID for identifying the AF | Management of AF requests and |
| | | | identification of network traffic |
| 5 | Sensing Type | Technical type of the requested | 3GPP-based: Time of Arrival |
| | | sensing operation; may use | (ToA), Angle of Arrival (AoA), |
| | | 3GPP-based signal analysis or | Received Signal Strength |
| | | auxiliary data | Indicator (RSSI), etc. |
| | | | Auxiliary data: Complementary |
| | | | use of LiDAR or ultrasonic sensor |
| | | | data |
| 6 | Sensing | Object or location information to | Specific vehicle, building, or GPS |
| | Target | be sensed | coordinates |
| 7 | Sensing | Temporal and spatial scope | Sensing during a specific time |
| | Range | where sensing data is required | period, data collection within a |
| | | | radius of 100 meters |
| 8 | QoS | Requirements for service | Delay of up to 10 ms, data |
| | Requirements | quality | reliability of 99.9% |
| 9 | Service | Network configuration | Frequency band, transmission |
| | Configuration | information for performing the | power, bandwidth, etc. |
| | Parameters | sensing operation | |
| 10 | Policy Data | Policy parameters required for | QoS management, user |
| | | service configuration | prioritization, etc. |
| 11 | Transmission | Standard format used for | JSON, XML, etc. |
| | Format | transmitting sensing data | |
| 12 | Sensing | Data collected based on 3GPP | Frequency band, signal strength, |
| | Measurement | standards | etc. |
| | Data | | |
| 13 | Requested | Form of the result data (e.g. | Result data type appropriate for |
| | Result Type | coordinates, event occurrence) | the requested service purpose |
| 14 | Equipment | Location information of | Location data for improving |
| | Location | equipment in the network | sensing result accuracy |
| | Information | | |
| 15 | Configuration | Parameters controlling the | Transmission frequency, |
| | Parameters | operation of sensing equipment | synchronization information, |
| | | | transmission power |
| 16 | Sensing | Detailed technical attributes of | Frequency band, transmission |
| | Attributes | sensing equipment | power, accuracy level |
| 17 | Result | Attributes and status | Result generation time, data |
| | Metadata | information of result data | source (3GPP/auxiliary data), etc. |
| 18 | Final Result | Final data generated as a | Object information, reliability |
| | Data | sensing result | score, etc. |
| 19 | Trigger | Conditions triggering network or | Sensing start time, specific event |
| | Conditions | service operations | conditions |
| 20 | Data Range | Temporal/spatial scope of | e.g. 10 seconds, 1 km radius |
| | | measurement or sensing data | |
| 21 | Analysis | Additional information required | Analysis algorithm, QoS status |
| | Metadata | for data processing and | |
| | | analysis | |

Referring again to FIGS. 10 to 13, input parameters of the sensing monitoring procedure according to an exemplary embodiment of the present disclosure may be configured with a focus on event-based data processing and can be defined as shown in Table 8.

TABLE 8

| No. | Parameter | Description | Usage and Example |
|---|---|---|---|
| 1 | User ID | Globally unique identifier for | Verification of the appropriateness of |
| | | uniquely identifying the | the ISAC monitoring service request |
| | | service requester | and session management |
| 2 | Request ID | Timestamp-based ID for | Prevention of duplicate requests, |
| | | uniquely identifying each | session tracking, and logging |
| | | request | |
| 3 | Service | Specification of the service | Selection of appropriate operation |
| | Request Type | type (environment sensing, | processes and resource allocation for |
| | | location sensing, detection, | each service |
| | | tracking) | |
| 4 | AF ID | Unique ID for identifying the | Management of AF requests and |
| | | AF | identification of network traffic |
| 5 | Sensing Type | Technical type of the | 3GPP-based: Time of Arrival (ToA), |
| | | requested sensing | Angle of Arrival (AoA), Received |
| | | operation; sensing using | Signal Strength Indicator (RSSI) |
| | | 3GPP-based wireless | Auxiliary data: LiDAR, ultrasonic |
| | | signals or auxiliary data | data, etc. |
| 6 | Sensing | Object or location | Specific vehicle, building, or GPS |
| | Target | information to be monitored | coordinates |
| 7 | Sensing | Temporal and spatial scope | Sensing during a specific time period, |
| | Range | where monitoring data is | data collection within a radius of 100 |
| | | required | meters |
| 8 | QoS | Requirements for service | Delay of up to 10 ms, data reliability of |
| | Requirements | quality | 99.9% |
| 9 | Service | Network configuration | Frequency band, transmission power, |
| | Configuration | information for performing | bandwidth, etc. |
| | Parameters | monitoring operations | |
| 10 | Policy Data | Policy parameters required | QoS management, user prioritization, |
| | | for service configuration | etc. |
| 11 | Transmission | Standard format used for | JSON, XML, etc. |
| | Format | transmitting sensing data | |
| 12 | Sensing Data | Unique ID for identifying a | Key for tracking results of each |
| | ID | specific sensing data set | sensing operation |
| 13 | Event | Detailed conditions and | Event start time, whether specific |
| | Parameters | trigger settings for sensing | conditions are met |
| | | event monitoring | |
| 14 | Status | Data describing the | Response status, description of |
| | Information | subscription request and | processing steps |
| | | processing status | |
| 15 | Final Result | Data generated as a result | Object information, event occurrence |
| | Data | of the sensing event | time, etc. |
| 16 | Result | Attributes and status | Result generation time, data source |
| | Metadata | information of result data | (3GPP/auxiliary data), etc. |
| 17 | Equipment | Location information of | Location data for improving sensing |
| | Location | equipment in the network | result accuracy |
| | Information | | |
| 18 | Configuration | Parameters controlling the | Transmission frequency, |
| | Parameters | operation of sensing | synchronization information, |
| | | equipment | transmission power |
| 19 | Sensing | Detailed technical attributes | Frequency band, transmission power, |
| | Attributes | of sensing equipment | accuracy level |
| 20 | Data Range | Temporal/spatial scope of | e.g., 10 seconds, 1 km radius |
| | | measurement or monitoring | |
| | | data | |
| 21 | Analysis | Additional information | Analysis algorithm, QoS status |
| | Metadata | required for data processing | |
| | | and analysis | |

Referring again to FIGS. 14 to 18, input parameters used in the sensing request procedure for the core network 100 including the SDRF 160 according to an exemplary embodiment of the present disclosure may include items related to data storage and retrieval and may be defined as shown in Table 9.

TABLE 9

| No. | Parameter | Description | Usage and Example |
|---|---|---|---|
| 1 | User ID | Globally unique identifier for | Verification of the |
| | | uniquely identifying the | appropriateness of the ISAC |
| | | service requester | service request and session |
| | | | management |
| 2 | Request ID | Timestamp-based ID for | Prevention of duplicate |
| | | uniquely identifying each | requests, session tracking, |
| | | request | and logging |
| 3 | Request Type | Specification of the type of | Selection of appropriate |
| | | ISAC service request (e.g., | operation processes and |
| | | environment sensing, | resource allocation for each |
| | | location sensing) | service |
| 4 | AF ID | Unique ID for identifying the | Management of AF requests |
| | | AF | and identification of network |
| | | | traffic |
| 5 | Sensing Type | Technical type of the | Utilization of 3GPP-based |
| | | requested sensing operation | wireless signals and |
| | | | external auxiliary data |
| 6 | Sensing Target | Object or location | Specific vehicle, building, or |
| | | information to be sensed | GPS coordinates |
| 7 | Sensing Range | Temporal and spatial scope | Sensing during a specific |
| | | where sensing data is | time period, data collection |
| | | required | within a radius of 100 meters |
| 8 | QoS | Requirements for service | Delay of up to 10 ms, data |
| | Requirements | quality | reliability of 99.9% |
| 9 | Service | Network configuration | Frequency band, |
| | Configuration | information for performing | transmission power, |
| | Parameters | sensing operations | bandwidth, etc. |
| 10 | SDRF Location | Address information | Information for discovering |
| | Information | indicating the network | and interacting with the |
| | | location of the SDRF | SDRF |
| 11 | Data Index | Index or data key for | Efficient retrieval and |
| | | retrieving data from the | management of specific |
| | | SDRF | sensing data sets |
| 12 | Location | Value indicating the location | Geographical or network |
| | Information | of sensing equipment or | location of UE and NG-RAN |
| | | data | |
| 13 | Transmission | Standard format used for | JSON, XML, etc. |
| | Format | transmitting sensing data | |
| 14 | Sensing | Detailed technical attributes | Frequency band, |
| | Attributes | of sensing equipment | transmission power, |
| | | | accuracy level |
| 15 | Configuration | Parameters controlling the | Transmission frequency, |
| | Parameters | operation of sensing | synchronization information, |
| | | equipment | transmission power |
| 16 | Policy Data | Policies controlling sensing | Priority management for |
| | | and network operations | sensing data processing, |
| | | | security policies |
| 17 | Measurement | Specific requirements for | Data resolution, |
| | Requirements | performing sensing data | measurement period, |
| | | measurements | measurement time |
| 18 | Calculation | Constraints required for data | QoS constraints, analysis |
| | Requirements | analysis and result | delay time |
| | | calculation | |
| 19 | Result Metadata | Attributes and status | Result generation time, data |
| | | information of sensing result | source (3GPP/auxiliary |
| | | data | data) |
| 20 | Final Result | Final data generated as a | Object information, reliability |
| | Data | sensing result | score |
| 21 | Processing | Policy for distributed | Data localization, storage |
| | Policy | processing or storage of | replication criteria |
| | | data in the SDRF | |
| 22 | Response | Success or failure status | Request success, failure, |
| | Status | information of the request | status code |

Referring again to FIGS. 19 to 23, input parameters used in the AI-enhanced sensing request procedure that performs AI-based analysis by utilizing the NWDAF 150 according to an exemplary embodiment of the present disclosure may be defined as shown in Table 10.

TABLE 10

| No. | Parameter | Description | Usage and Example |
|---|---|---|---|
| 1 | User ID | Globally unique identifier | Verification of the |
| | | for uniquely identifying the | |
| | | service requester | appropriateness of the ISAC |
| | | | service request and session |
| | | | management |
| 2 | Request ID | Timestamp-based ID for | Prevention of duplicate requests, |
| | | uniquely identifying each | session tracking, and logging |
| | | request | |
| 3 | Request Type | Specification of the type of | Selection of appropriate |
| | | ISAC service request (e.g., | operation processes and |
| | | environment sensing, | resource allocation for each |
| | | location sensing) | service |
| 4 | AF ID | Unique ID for identifying | Management of AF requests and |
| | | the AF | identification of network traffic |
| 5 | Sensing Type | Technical type of the | Utilization of 3GPP-based |
| | | requested sensing | wireless signals and external |
| | | operation | auxiliary data |
| 6 | Sensing Target | Object or location | Specific vehicle, building, or GPS |
| | | information to be sensed | coordinates |
| 7 | Sensing Range | Temporal and spatial | Sensing during a specific time |
| | | scope where sensing data | period, data collection within a |
| | | is required | radius of 100 meters |
| 8 | QoS | Requirements for service | Delay of up to 10 ms, data |
| | Requirements | quality | reliability of 99.9% |
| 9 | Service | Network configuration | Frequency band, transmission |
| | Configuration | information for performing | power, bandwidth, etc. |
| | Parameters | sensing operations | |
| 10 | Data | Requirements for | QoS-based optimization, |
| | Preprocessing | optimizing data | allowable preprocessing delay |
| | Requirements | preprocessing by NWDAF | time |
| 11 | Optimized Data | Data preprocessing | Sensing data filtering, application |
| | Processing Rules | optimization rules provided | of preprocessing algorithms |
| | | as a result of NWDAF | |
| | | analysis | |
| 12 | Sensing | ID for uniquely identifying | Identification of specific sensing |
| | Equipment ID | sensing equipment | equipment within NG-RAN or UE |
| 13 | Configuration | Parameters controlling the | Transmission frequency, |
| | Parameters | operation of sensing | synchronization information, |
| | | equipment | transmission power |
| 14 | Discovery | Criteria for discovering | Equipment location, supported |
| | Parameters | available sensing | frequency band, network status |
| | | equipment | |
| 15 | Sensing | Request information for | QoS metadata, sensing |
| | Equipment | optimizing equipment | equipment status |
| | Setting | settings by NWDAF | |
| | Optimization | | |
| | Request | | |
| 16 | Optimized Setting | Optimized setting | Optimal transmission power, |
| | Values | information provided | optimal frequency band |
| | | through NWDAF analysis | |
| 17 | Measurement | Specific requirements for | Data resolution, measurement |
| | Requirements | performing sensing data | period, measurement time |
| | | measurements | |
| 18 | Analysis | Additional information | QoS requirements, analysis |
| | Metadata | required for result | algorithm |
| | | calculation | |
| 19 | Result Calculation | Request information for | Result calculation delay time, |
| | Optimization | optimizing result | QoS metadata |
| | Request | calculation by NWDAF | |
| 20 | Optimized Calculation | Optimized calculation | Improvement of result data |
| | Values | information provided | accuracy, reduction of |
| | | through NWDAF analysis | calculation delay time |
| 21 | Result Metadata | Attributes and status | Result generation time, data |
| | | information of sensing | source (3GPP/auxiliary data) |
| | | result data | |
| 22 | Final Result Data | Final data generated as a | Object information, reliability |
| | | sensing result | score |
| 23 | Response Status | Success or failure status | Request success, failure, status |
| | | information of the request | code |

Referring to FIG. 4 and FIGS. 6 to 9, a sensing method using ISAC according to an exemplary embodiment of the present disclosure may comprise: a step of receiving a sensing request for obtaining sensing information of a target via a communicable sensing entity (S710, S712); a step of generating a sensing trigger based on the sensing request (S720); and a step of communicating with the sensing entity to perform sensing on the target using preconfigured sensing device configuration information based on the sensing trigger (S730).

The preconfigured sensing device configuration information may include information on a sensing device capable of sensing the target and the sensing entity associated with the sensing device.

In exemplary embodiments of the present disclosure, a sensing entity may refer to an entity among communication entities of a network, such as RAN, that is connected to a sensing equipment (or sensing device) or capable of controlling the sensing device.

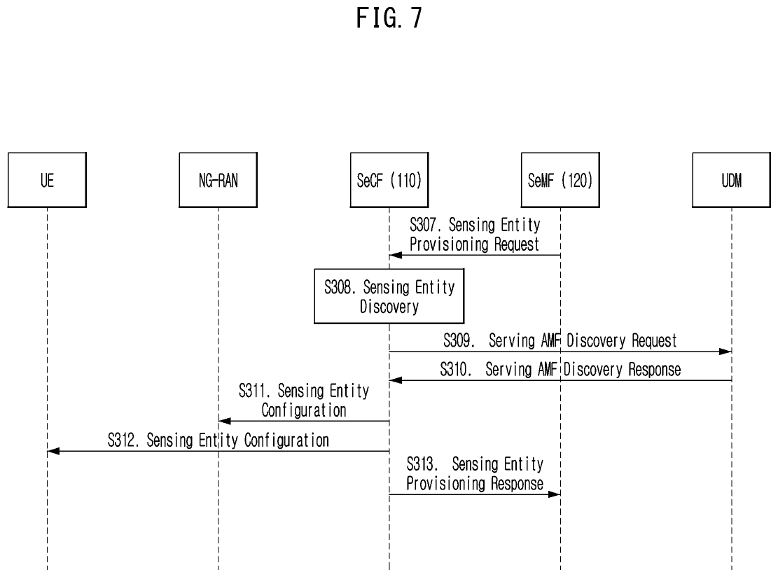

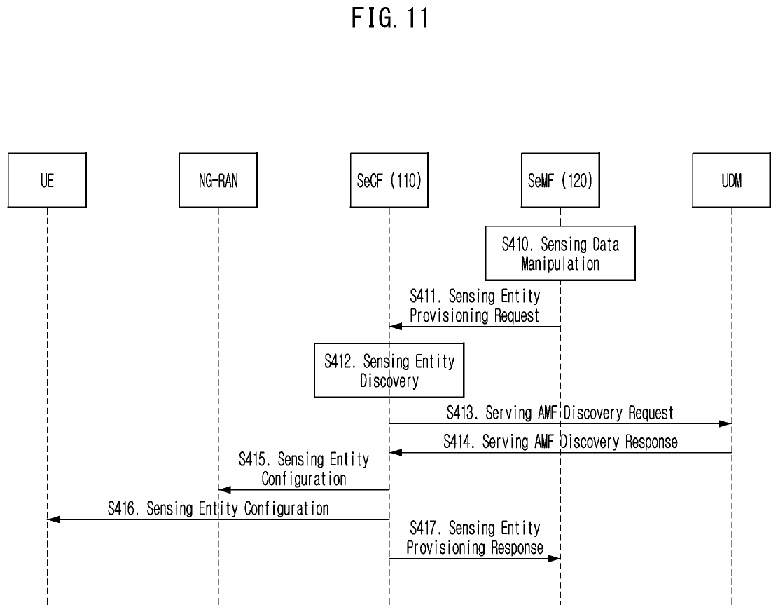

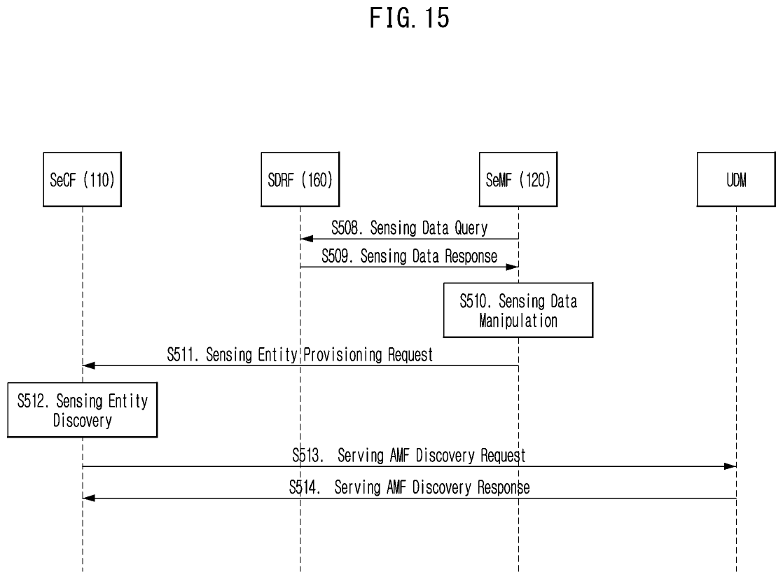

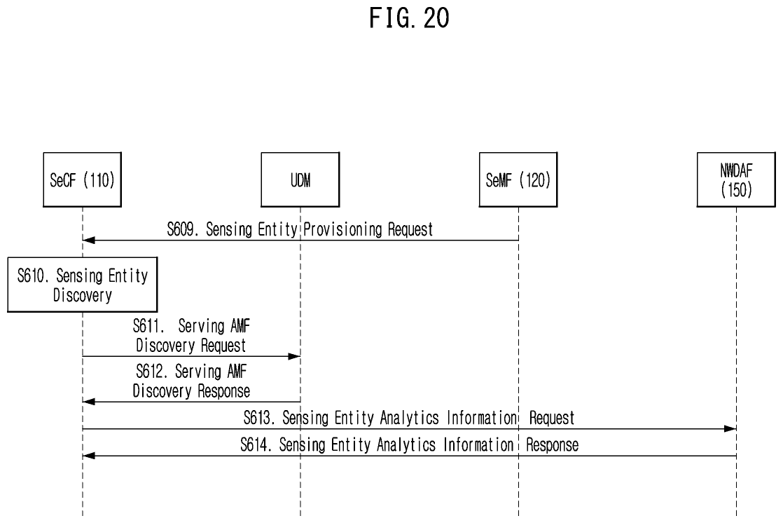

The sensing trigger may correspond to S720 of FIG. 4, or may refer to the sensing entity provisioning request transmitted from the SeMF 120 to the SeCF 110. For example, the sensing trigger may correspond to the process illustrated in S307 of FIG. 7, S411 of FIG. 11, S511 of FIG. 15, or S609 of FIG. 20.

The step of communicating with the sensing entity (S730) may refer to the entire processes in which the SeCF 110 communicates with at least one sensing entity (NG-RAN and/or UE) through a sensing entity discovery step (S308, S412, S512, S610) to perform sensing, including the processes shown as S311, S312, S415, S416, S515, S516, S615, and S616.

The sensing method using ISAC according to an exemplary embodiment of the present disclosure may further include a step of obtaining information regarding an AMF NF related to the preconfigured sensing device configuration information from a UDM NF based on the sensing trigger (S309, S310 of FIG. 7, S413, S414 of FIG. 11, S513, S514 of FIG. 15, and S611, S612 of FIG. 20). In this case, information on an AMF (i.e. serving AMF capable of serving for the sensing procedure) capable of managing the sensing entity (which may include a gNB or a UE) that can participate in sensing for the sensing target may be acquired from the UDM.

In the sensing method using ISAC according to an exemplary embodiment of the present disclosure, in the step of communicating with the sensing entity (S730), configuration parameters or control policies related to the sensing device of the sensing entity may be transmitted to the sensing entity. The sensing method using ISAC according to an exemplary embodiment of the present disclosure may further comprise, after transmission of the configuration parameters or control policies related to the sensing device, managing sensing device configuration results including configuration parameters or control policies of the sensing device of the sensing entity.

The SeCF 110 may transmit sensing entity configuration information to the SeMF 120 as a sensing entity provisioning response (S313, S417, S517, S617), the SeMF 120 may receive the sensing entity configuration information, and thereafter, the SeMF 120 may manage the sensing entity (RAN and/or UE) and receive sensing data from the sensing entity using the sensing entity configuration information.

The sensing method using ISAC according to an exemplary embodiment of the present disclosure may further comprise a step of discovering the SDRF 160 for storing and processing sensing data in a localized data storage based on the sensing request (i.e. SDRF discovery, S506, S507).

In this case, the sensing method using ISAC according to an exemplary embodiment of the present disclosure may further comprise a step of processing the sensing data received by the SDRF 160 from the sensing entity (S525), and a step of transmitting the processed sensing data together with information on the SDRF 160 to the SeMF 120 for management (S527).

The sensing method using ISAC according to an exemplary embodiment of the present disclosure may further comprise, based on the sensing request, performing at least one of preprocessing of sensing data (S606, S607), analysis of sensing data (S625, S626), optimization of sensing entity configuration (S613, S614), or analysis of sensing result calculation (S625, S626) using the NWDAF 150.

In this case, in the sensing method using ISAC according to an exemplary embodiment of the present disclosure, the NWDAF 150 may perform at least one of preprocessing of sensing data (S606, S607), analysis of sensing data (S625, S626), optimization of sensing entity configuration (S613, S614), or analysis of sensing result calculation (S625, S626) using an artificial intelligence-based or machine learning-based analysis function. A sensing service provisioning method using ISAC according to another exemplary embodiment of the present disclosure may comprise: a step of receiving a sensing monitoring request including an event condition for obtaining sensing information of a target via a communicable sensing entity (S710, S712); a step of communicating with the sensing entity to perform sensing on the target using preconfigured sensing device configuration information based on the sensing monitoring request (S720, S730); a step of receiving sensing data from the sensing entity (S740); a step of generating an analysis result of the sensing data based on whether the event condition is satisfied (S750); and a step of providing the analysis result in response to the sensing monitoring request (S760, S762).

In this case, in the sensing service providing method using ISAC according to an exemplary embodiment of the present disclosure, the preconfigured sensing device configuration information may include information on a sensing device capable of sensing the target and the sensing entity associated with the sensing device.

The sensing service provisioning method using ISAC according to an exemplary embodiment of the present disclosure may further include discovering the SDRF 160 for storing and processing sensing data in a localized data storage based on the sensing monitoring request.

In this case, the sensing service provisioning method using ISAC according to an exemplary embodiment of the present disclosure may further comprise: a step of processing sensing data received by the SDRF 160 from the sensing entity and a step of managing the processed sensing data together with information on the SDRF 160.

The sensing service provisioning method using ISAC according to an exemplary embodiment of the present disclosure may further comprise, based on the sensing monitoring request, performing at least one of preprocessing of sensing data, analysis of sensing data, optimization of sensing entity configuration, or analysis of sensing result calculation using the NWDAF 150.

FIG. 24 is a conceptual diagram illustrating an example of a generalized computing system in which an entity or a part thereof in the core network 100 capable of performing at least part of the processes in FIGS. 1 to 23 may be implemented.

At least some of the processes such as sensing, computation, data processing, data transmission, and reception performed by an entity performing at least a part of NFs in the core network 100 and the sensing entity involved in the sensing process for the target according to exemplary embodiments of the present disclosure may be executed by the computing system 1000 of FIG. 24.

Referring to FIG. 24, the computing system 1000 according to an exemplary embodiment of the present disclosure may include a processor 1100, a memory 1200, a communication interface 1300, a storage device 1400, an input interface 1500, an output interface 1600, and a bus 1700.

The computing system 1000 according to an exemplary embodiment of the present disclosure may include the at least one processor 1100 and the memory 1200 that stores instructions causing the at least one processor 1100 to perform at least one step. At least a portion of the steps of the method according to an exemplary embodiment of the present disclosure may be performed by the at least one processor 1100 that loads the instructions from the memory 1200 and executes the instructions.

The processor 1100 may refer to a central processing unit (CPU), a graphics processing unit (GPU), or a dedicated processor on which the methods according to the exemplary embodiments of the present disclosure are performed.

Each of the memory 1200 and the storage device 1400 may include at least one of a volatile storage medium and a non-volatile storage medium. For example, the memory 1200 may include at least one of a read-only memory (ROM) and a random access memory (RAM).

The computing system 1000 may further include the communication interface 1300 for performing communication through a wireless network.

The computing system 1000 may further include the storage device 1400, the input interface 1500, and the output interface 1600.

The respective components included in the computing system 1000 may communicate with one another by being connected via the bus 1700.

A communication network system using ISAC according to another exemplary embodiment of the present disclosure may include at least one entity, and the at least one entity may include the computer-readable memory 1200 storing at least one instruction, and the processor 1100 executing the at least one instruction.

In this case, in the communication network system using ISAC according to an exemplary embodiment of the present disclosure, the at least one entity may receive a sensing request for obtaining sensing information of a target via a communicable sensing entity, may generate a sensing trigger based on the sensing request (S720), and may communicate with the sensing entity to perform sensing on the target using preconfigured sensing device configuration information based on the sensing trigger (S730).

In this case, in the communication network system using ISAC according to an exemplary embodiment of the present disclosure, the preconfigured sensing device configuration information may include information on a sensing device capable of sensing the target and the sensing entity associated with the sensing device.

In the communication network system using ISAC according to an exemplary embodiment of the present disclosure, the at least one entity may obtain information regarding an AMF NF related to the preconfigured sensing device configuration information from the UDM NF based on the sensing trigger.

In the communication network system using ISAC according to an exemplary embodiment of the present disclosure, when communicating with the sensing entity (S730), configuration parameters or control policies related to the sensing device of the sensing entity may be transmitted to the sensing entity.

In this case, in the communication network system using ISAC according to an exemplary embodiment of the present disclosure, the at least one entity may manage sensing device configuration results including configuration parameters or control policies of the sensing device of the sensing entity after transmission of the configuration parameters or control policies related to the sensing device.

The at least one entity may discover the SDRF 160 for storing and processing sensing data in a localized data storage based on the sensing request. In this case, the at least one entity may process sensing data received by the SDRF 160 from the sensing entity and may manage the processed sensing data together with information on the SDRF 160.

In this case, the at least one entity may process sensing data received by the SDRF 160 from the sensing entity and may manage the processed sensing data together with information on the SDRF 160.

The at least one entity may perform at least one of preprocessing of sensing data, analysis of sensing data, optimization of sensing entity configuration, or analysis of sensing result calculation using the NWDAF 150 based on the sensing request.

The at least one entity may provide an analysis result of sensing data received via the sensing entity in response to the sensing request based on whether an event condition included in the sensing request is satisfied (S760, S762).

An example of the computing system 1000 of the present disclosure may include a communicable desktop computer, laptop computer, notebook, smartphone, tablet PC, mobile phone, smartwatch, smart glasses, e-book reader, portable multimedia player (PMP), portable gaming device, navigation device, digital camera, digital multimedia broadcasting (DMB) player, digital audio recorder, digital audio player, digital video recorder, digital video player, or personal digital assistant (PDA), and/or the like.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A sensing method using integrated sensing and communication (ISAC), comprising:
receiving, via a sensing entity capable of communicating, a sensing request to obtain sensing information of a target;
generating a sensing trigger based on the sensing request; and
communicating with the sensing entity so that sensing of the target is performed using preconfigured sensing device configuration information, based on the sensing trigger,
wherein the preconfigured sensing device configuration information includes information on a sensing device capable of sensing the target and the sensing entity associated with the sensing device.

2. The sensing method according to claim 1, further comprising: obtaining information on an Access and Mobility Management (AMF) network function (NF) related to the preconfigured sensing device configuration information from a Unified Data Management (UDM) NF, based on the sensing trigger.

3. The sensing method according to claim 1, further comprising:
transmitting, to the sensing entity, configuration parameters or a control policy related to the sensing device of the sensing entity while communicating with the sensing entity; and
after transmitting the configuration parameters or the control policy related to the sensing device, managing a result of configuring the sensing device based on the configuration parameters or the control policy of the sensing device of the sensing entity.

4. The sensing method according to claim 1, further comprising: discovering a sensing data repository function (SDRF) for storing and processing sensing data in a localized data storage based on the sensing request.

5. The sensing method according to claim 4, further comprising:
processing sensing data received by the SDRF from the sensing entity; and
managing the processed sensing data together with information on the SDRF.

6. The sensing method according to claim 1, further comprising: performing, by using a Network Data Analytics Function (NWDAF), at least one of preprocessing of sensing data, analysis of the sensing data, optimization of configuration of the sensing entity, or analysis of sensing result calculation based on the sensing request.

7. The sensing method according to claim 6, wherein the NWDAF performs at least one of the preprocessing of the sensing data, the analysis of the sensing data, the optimization of the configuration of the sensing entity, or the analysis of the sensing result calculation using an analysis function based on artificial intelligence or machine learning.

8. A sensing service provisioning method using integrated sensing and communication (ISAC), comprising:
receiving, via a sensing entity capable of communicating, a sensing monitoring request for obtaining sensing information of a target, the sensing monitoring request including an event condition;
communicating with the sensing entity so that sensing of the target is performed using preconfigured sensing device configuration information, based on the sensing monitoring request;
receiving sensing data from the sensing entity;
generating an analysis result for the sensing data based on whether the event condition is satisfied; and
providing the analysis result in response to the sensing monitoring request,
wherein the preconfigured sensing device configuration information includes information on a sensing device capable of sensing the target and the sensing entity associated with the sensing device.

9. The sensing service provisioning method according to claim 8, further comprising: discovering a sensing data repository function (SDRF) for storing and processing the sensing data in a localized data storage based on the sensing monitoring request.

10. The sensing service provisioning method according to claim 9, further comprising:
processing the sensing data received by the SDRF from the sensing entity; and
managing the processed sensing data together with information on the SDRF.

11. The sensing service provisioning method according to claim 8, further comprising: performing, by using a Network Data Analytics Function (NWDAF), at least one of preprocessing of the sensing data, analysis of the sensing data, optimization of configuration of the sensing entity, or analysis of sensing result calculation based on the sensing request.

12. The sensing service provisioning method according to claim 11, wherein the NWDAF performs at least one of the preprocessing of the sensing data, the analysis of the sensing data, the optimization of the configuration of the sensing entity, or the analysis of the sensing result calculation using an analysis function based on artificial intelligence or machine learning.

13. A communication network system using integrated sensing and communication (ISAC), comprising: at least one entity,
wherein the at least one entity comprises:
a computer-readable memory storing at least one executable instruction; and
a processor executing the at least one instruction,
wherein the at least one entity is configured to:
receive, via a sensing entity capable of communicating, a sensing request to obtain sensing information of a target;
generate a sensing trigger based on the sensing request; and
communicate with the sensing entity so that sensing of the target is performed using preconfigured sensing device configuration information, based on the sensing trigger,
wherein the preconfigured sensing device configuration information includes information on a sensing device capable of sensing the target and the sensing entity associated with the sensing device.

14. The communication network system according to claim 13, wherein the at least one entity is further configured to: obtain information on an Access and Mobility Management (AMF) network function (NF) related to the preconfigured sensing device configuration information from a Unified Data Management (UDM) NF, based on the sensing trigger.

15. The communication network system according to claim 13, wherein the at least one entity is further configured to:
transmit, to the sensing entity, configuration parameters or a control policy related to the sensing device of the sensing entity while communicating with the sensing entity; and
after transmitting the configuration parameters or the control policy related to the sensing device, manage a result of configuring the sensing device based on the configuration parameters or the control policy of the sensing device of the sensing entity.

16. The communication network system according to claim 13, wherein the at least one entity is further configured to: discover a sensing data repository function (SDRF) for storing and processing sensing data in a localized data storage based on the sensing request.

17. The communication network system according to claim 16, wherein the at least one entity is further configured to:
process sensing data received by the SDRF from the sensing entity; and
manage the processed sensing data together with information on the SDRF.

18. The communication network system according to claim 13, wherein the at least one entity is further configured to: perform, by using a Network Data Analytics Function (NWDAF), at least one of preprocessing of sensing data, analysis of the sensing data, optimization of configuration of the sensing entity, or analysis of sensing result calculation based on the sensing request.

19. The communication network system according to claim 18, wherein the NWDAF is further configured to perform at least one of the preprocessing of the sensing data, the analysis of the sensing data, the optimization of the configuration of the sensing entity, or the analysis of the sensing result calculation using an analysis function based on artificial intelligence or machine learning.

20. The communication network system according to claim 13, wherein the at least one entity is further configured to: provide, in response to the sensing request, an analysis result of sensing data received via the sensing entity based on whether an event condition included in the sensing request is satisfied.
